(19) United States
(12) Patent Application Publication
(10) Pub. No.: US 2010/0142756 A1
(43) Pub. Date: Jun. 10, 2010

(54) DOCUMENT SECURITY METHOD

(75) Inventors: Andrew James Fields, Cremorne (AU); Shaun Peter O'Keefe, Artarmon (AU)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/626,967

(22) Filed: Nov. 30, 2009

(30) Foreign Application Priority Data
Dec. 10, 2008 (AU) 2008255227

(51) Int. Cl. G06K 9/00

(52) U.S. Cl. 382/100

(57) ABSTRACT

Disclosed is a method (600) of protecting a document (715) containing document information content, the method comprising the steps of defining a regular grid (716) over the document (715), separating the grid intersection points into a repeating pattern of points (701-704), wherein each member of the repeating pattern comprises two subsets of points (705, 709) having a predefined spatial relationship, said subsets of points being associated with corresponding regions of the document (715), and modulating (506), with respect to each member of the repeating pattern (701-704), protection mark attributes of protection marks associated with one of said subsets of points (709), to thereby encode information about the document information content of the regions of the document associated with both said subsets of points (705, 709).

### CROSS-REFERENCE TO RELATED PATENT APPLICATIONS

This application claims the right of priority under 35 U.S.C. §119 based on Australian Patent Application No. 2008255227, filed 10 Dec. 2008, which is incorporated by reference herein in its entirety as if fully set forth herein.

### TECHNICAL FIELD OF THE INVENTION

The current invention relates to document security and in particular to methods of detecting areas of documents which have been tampered with.

### BACKGROUND

It is often desirable to ensure that an original printed document (referred to as the “original document” or the “unprotected document”) has not been copied, altered or tampered with in some unauthorized manner from the time the document was first printed. An unauthorised amendment is referred to as an example of “tampering”. An unauthorized copying is referred to as an example of an “attack”. The act of tampering is one example of an attack.

A contract that has been agreed upon and signed on some date may subsequently be fraudulently altered. It is desirable to be able to detect such tampering in detail. Similarly, documents such as cheques and monetary instruments record values, which are vulnerable to fraudulent alteration. Detection of any fraudulent alteration in such documents is also desirable. Further, it is desirable that such detection be performed automatically, and that the detection reveals the nature of any alteration.

One current way to approach this problem utilises a two-dimensional (2D) barcode or watermark printed on the original document to encode information about the original state of the original printed document. Information incorporated into a document for such purposes are referred to as ‘protection marks”. An original document into which protection marks have been incorporated is referred to as a “protected document”. The term “document” when used alone may refer to either an original document or a protected document, this being clear from the context. The advantage of the above-noted 2D protection mark approach is that the barcode encoding information about the printed document is co-located with, or close to, the document content it encodes. This makes the document largely self contained and also affords a number of security advantages making the protected document difficult to forge or alter. The 2D barcode is one example of a “security feature”, this being a term used to denote information that is printed on the document in order to facilitate detection and/or prevention of an attack.

The term “information content” (also referred to as document information content) is used in this description to denote the information content of the original document. In a more general sense, the document information content can also denote a characteristic of the document substrate, ie a characteristic of the physical medium upon which the document information content is printed. The term “protection content” is used to denote the information contained in the security feature(s).

Adding complementary security features to a document may improve the ability to detect attacks and damage to the protected document. Complementary features may take the form of a second 2D barcode, other visually observable security features such as watermarks, holograms or other high end printing processes, or may even be part of the first 2D barcode. These complementary security features typically perform some security function which complements but is different to the first security function. However, there is generally a strong relationship between the space on a document which is used by a 2D barcode, and the data capacity of the 2D barcode. While the benefits of combining multiple security features in a document are considerable, care must be taken to avoid limiting the performance of existing security features by taking up additional space on the document for additional security features.

One anti-tamper approach employs a series of low visibility protection marks, which encode information about the image information content of the document. Such methods allow the information about the image content of the document to be distributed across the entire document, making it harder to circumvent the protection afforded by the protection marks, as any damage to the page will constitute damage to the protection marks. When using this approach, however, it is difficult to add complimentary security features, as additional features which either share the protection marks and/or obscure parts of the protection marks generally result in a degradation in the overall performance of the protection.

### SUMMARY

It is an object of the present invention to substantially overcome, or at least ameliorate, one or more disadvantages of existing arrangements.

Disclosed are arrangements (referred to as Spatially Related Data Channel or SRDC arrangements) which seek to address at least some of the above problems by separating protection marks into two data channels, where one of the channels can carry arbitrary information, while the other channel encodes security anti-tamper information for those regions of the document associated with both channels. This approach obviates the need to use the first channel for the anti-tamper function, and thus minimises constraints on the use of the first channel.

According to a first aspect of the present invention, there is provided a method of creating a protected document, the method comprising the steps of:

(a) providing a document having a plurality of marks encoding a security feature of the document, the plurality of marks having a structured arrangement corresponding to a plurality of areas, each area comprising a first region for storing security data and a second region for storing information related to an anti-tamper attribute of the first region;

(b) determining, based on the structured arrangement and a predetermined mapping for each said area, a correspondence between the first and second regions; and

(c) modulating the marks in the second regions to at least encode a characteristic of the first regions, wherein the modulated marks provide anti-tamper protection for the first region to create the protected document.

According to another aspect of the present invention, there is provided a method of protecting a document containing document information content, the method comprising the steps of:

defining a grid over the document the grid having grid intersection points whose locations relative to each other are predefined;

separating the grid intersection points into a repeating pattern of points, wherein each member of the repeating pattern comprises two subsets of points having a predefined spatial relationship, said subsets of points being associated with corresponding regions of the document; and

modulating, with respect to each member of the repeating pattern, protection mark attributes of protection marks associated with one of said subsets of points, to thereby encode information about the document information content of the regions of the document associated with both said subsets of points.

According to another aspect of the present invention, there is provided a method of creating a security document, the method comprising the steps of:

(a) providing a document having a plurality of marks encoding a security feature of the document, the plurality of marks having a structured arrangement corresponding to a plurality of areas, each area comprising a first region for storing security data comprising a repeating pattern of dots, and a second region for storing information related to an anti-tamper attribute of the area;

(b) determining, based on the structured arrangement and a predetermined mapping for each said area, a correspondence between the second regions and the entire area; and

(c) modulating some marks in the second region to encode a characteristic of the area, wherein the modulated marks provide an anti-tamper protection for the area to create the security document.

According to another aspect of the present invention, there is provided a method of decoding a protected document, the method comprising the steps of:

(a) providing a document having a plurality of modulated marks encoding a security feature of the document, the plurality of marks having a structured arrangement corresponding to a plurality of areas, each area comprising a first region for storing security data and a second region for storing information related to an anti-tamper attribute of the first region;

(b) determining, based on the structured arrangement and a predetermined mapping for each said area, a correspondence between the first and second regions; and

(c) demodulating the marks in the second regions to recover an anti-tamper protection characteristic of the first regions.

According to another aspect of the present invention, there is provided an apparatus for implementing any one of the aforementioned methods.

According to another aspect of the present invention there is provided a computer program product including a computer readable medium having recorded thereon a computer program for implementing any one of the aforementioned methods.

Other aspects of the invention are also disclosed.

### BRIEF DESCRIPTION OF THE DRAWINGS

One or more embodiments of the invention will now be described with reference to the following drawings, in which:

FIGS. 1A and 1B form a schematic block diagram of a general purpose computer system upon which the SRDC arrangements described can be practiced;

FIG. 2 illustrates a portion of a protected document;

FIG. 3 illustrates the modulation of a protection mark (also referred to as a protection dot);

FIG. 4 illustrates the initial positions for the protection dots on a portion of the protected document (alignment dots are not explicitly illustrated);

FIG. 5 illustrates an enlarged view of the modulation of a protection dot;

FIG. 6 is a flow diagram illustrating a method of encoding a protected document;

FIG. 7 illustrates the layout of a number of tiles containing a repeating pattern of protection dots;

FIG. 8 is a flow diagram illustrating a method for selecting a first channel of protection dots and encoding a first security feature in those protection dots;

FIG. 9 is a flow diagram illustrating a method for selecting a second channel of protection dots and encoding a second security feature in those protection dots;

FIG. 10 illustrates the area used to calculate average pixel intensity;

FIG. 11 illustrates a grid containing pseudo-random values which are used to modulate protection dots on a page to encrypt data;

FIG. 12 illustrates a scheme for assigning a pixel density value to a grid cell;

FIG. 13 is a flow diagram illustrating a method of assigning values to the second channel of protection dots from sample points;

FIG. 14 illustrates one possible layout of sampling points within a tile;

FIG. 15 illustrates a scheme for selecting ancillary data dots;

FIG. 16 is a flow diagram illustrating a method of decoding a protected document;

FIG. 17 is a flow diagram illustrating a method of extracting intervals from protection dots on the document;

FIG. 18 is a flow diagram illustrating a method of identifying the first channel structure and extracting the security feature from the first channel;

FIG. 19A illustrates the order of assignment for logical co-ordinates;

FIG. 19B illustrates a repeated pattern and the structure it defines, as well as the values decoded in the grid;

FIG. 20 illustrates a portion of a tampered document where an “E” has been changed to an “8”;

FIG. 21 illustrates the area used to calculate the average pixel intensity on the tampered document;

FIG. 22 illustrates a scheme for mapping a protection dot location to an interval;

FIG. 23 is a flow chart illustrating a method for determining which area on the document a second channel encodes;

FIG. 24 illustrates the random grid with values missing

FIG. 25 illustrates a scheme for extracting data values from the values encoded in the second channel protection dots;

FIG. 26 illustrates an alternate modulation scheme;

FIG. 27 illustrates the altered area highlighted on the tampered document;

FIG. 28 depicts a protected document which has been altered in an unauthorised manner, after processing using the disclosed SRDC arrangements; and

FIG. 29 is a process and data flow diagram depicting how the disclosed SRDC arrangement operates.

### DETAILED DESCRIPTION INCLUDING BEST MODE

### Introduction

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of arrangements which form public knowledge through their use. Such discussions should not be interpreted as a representation by the present inventor(s) or the patent applicant that arrangements in any way form part of the common general knowledge in the art.

As previously noted, the term “information content” (also referred to as document information content) is used in this description to denote the information content of the original document. In a more general sense, the document information content can also denote a characteristic of the document substrate, ie a characteristic of the physical medium upon which the document information content is printed. The term “protection content” is used to denote the information contained in the security feature(s).

### Generating Protected Documents

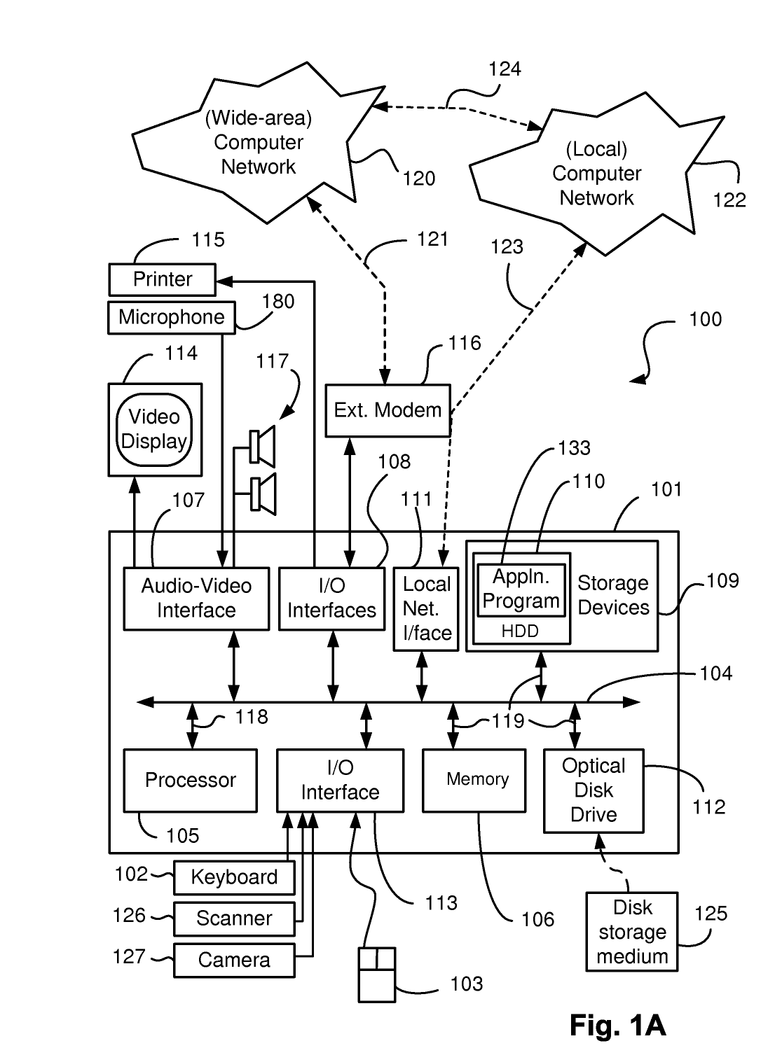

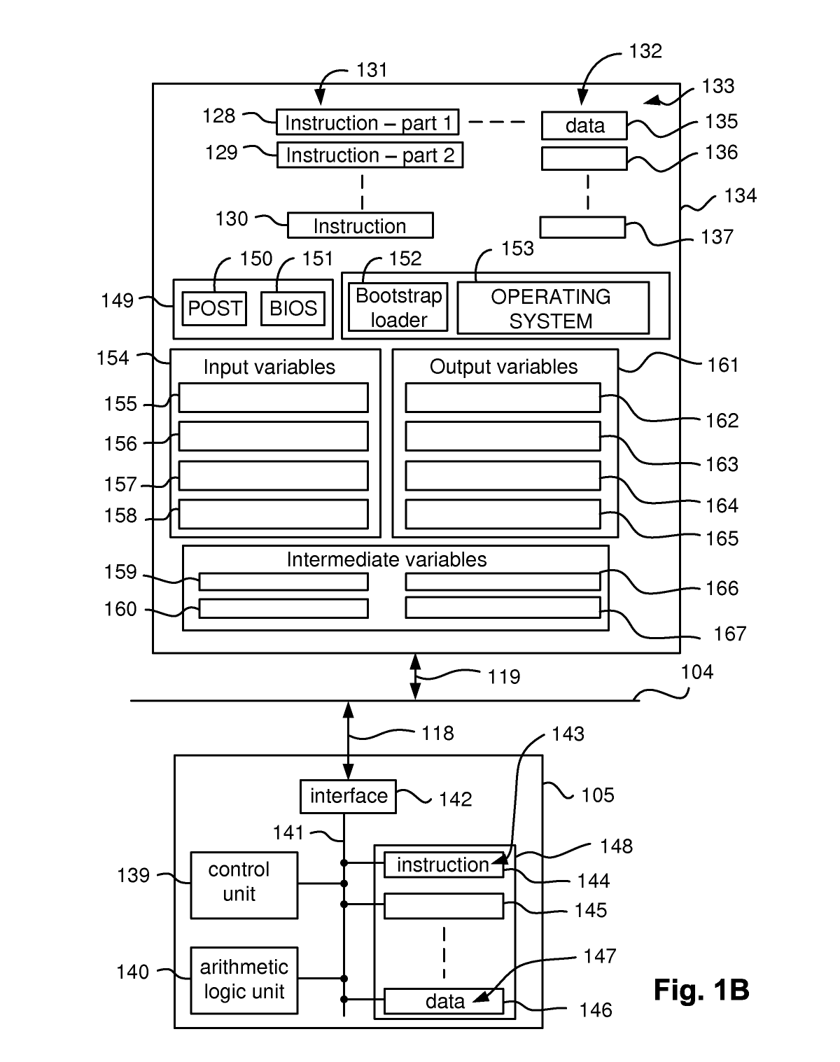

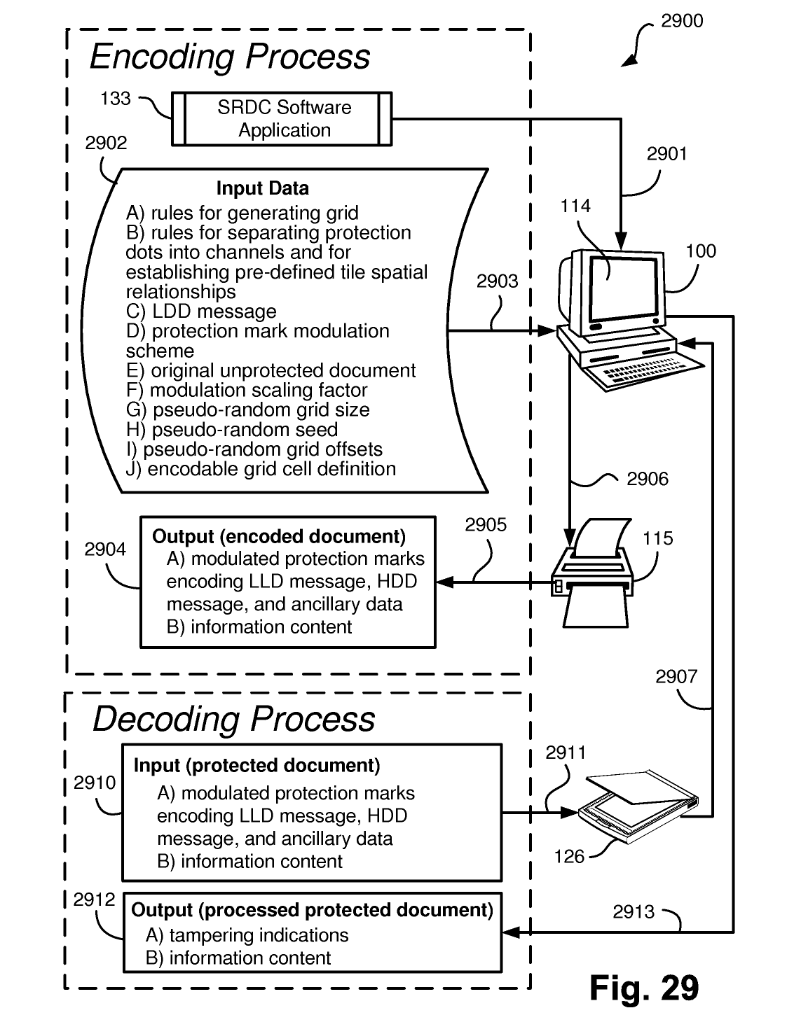

FIGS. 1A and 1B collectively form a schematic block diagram of a general purpose computer system apparatus 100, upon which the various SRDC arrangements described can be practiced. Although the SRDC encoding arrangement and the SRDC decoding arrangement are often performed on different computer systems, only a single computer system 100 is depicted in FIGS. 1A and 1B, (and in FIG. 29) as the functionality of this system 100 will typically be the same for both encoding and decoding arrangements. In particular, this presumes that the SRDC software application 133 encompasses both encoding and decoding functionality (as depicted by 133 in FIGS. 29 and 30). In alternate arrangements, the software application 133 can be partitioned into separate encoding and decoding modules, which are run on respective encoding and decoding computer systems.

As seen in FIG. 1A, the computer system 100 is formed by a computer module 101, input devices such as a keyboard 102, a mouse pointer device 103, a scanner 126, a camera 127, and a microphone 180, and output devices including a printer 115, a display device 114 and loudspeakers 117. The printer 115 may be in the form of an electro-photographic printer, an ink-jet printer or the like. The scanner 126 may be in the form of a flatbed scanner, for example, that may be used to scan a barcode or other arrangement of protection marks or security feature, in order to generate a scanned image thereof. The scanner 119 may be configured within the chassis of a multi-function printer. An external Modulator-Demodulator (Modem) transceiver device 116 may be used by the computer module 101 for communicating to and from a communications network 120 via a connection 121. The network 120 may be a wide-area network (WAN), such as the Internet or a private WAN. Where the connection 121 is a telephone line, the modem 116 may be a traditional “dial-up” modem. Alternatively, where the connection 121 is a high capacity (eg: cable) connection, the modem 116 may be a broadband modem. A wireless modem may also be used for wireless connection to the network 120.

The computer module 101 typically includes at least one processor unit 105, and a memory unit 106 for example formed from semiconductor random access memory (RAM) and semiconductor read only memory (ROM). The module 101 also includes an number of input/output (I/O) interfaces including an audio-video interface 107 that couples to the video display 114, loudspeakers 117 and microphone 180, an I/O interface 113 for the keyboard 102, mouse 103, scanner 126, camera 127 and optionally a joystick (not illustrated), and an interface 108 for the external modem 116 and printer 115. In some implementations, the modem 116 may be incorporated within the computer module 101, for example within the interface 108. The computer module 101 also has a local network interface 111 which, via a connection 123, permits coupling of the computer system 100 to a local computer network 122, known as a Local Area Network (LAN). As also illustrated, the local network 122 may also couple to the wide network 120 via a connection 124, which would typically include a so-called “firewall” device or device of similar functionality. The interface 111 may be formed by an Ethernet™ circuit card, a Bluetooth™ wireless arrangement or an IEEE 802.11 wireless arrangement.

The interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (eg: CD-ROM, DVD), USB-RAM, and floppy disks for example may then be used as appropriate sources of data to the system 100.

The components 105 to 113 of the computer module 101 typically communicate via an interconnected bus 104 and in a manner which results in a conventional mode of operation of the computer system 100 known to those in the relevant art. Examples of computers on which the described arrangements can be practiced include IBM-PC' s and compatibles, Sun Sparcstations, Apple Mac™ or alike computer systems evolved therefrom.

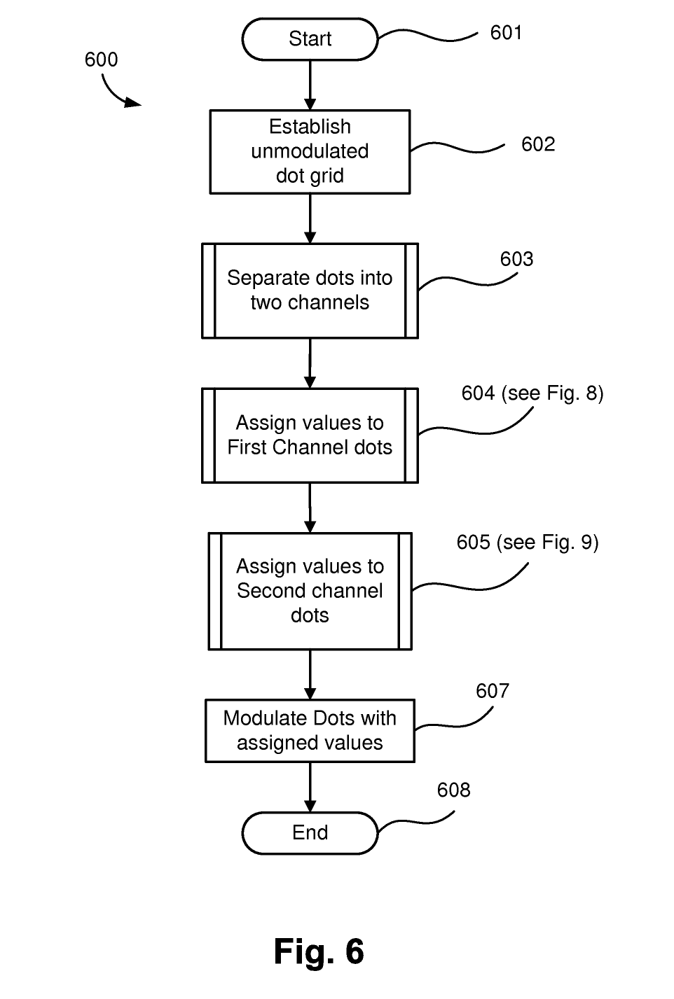

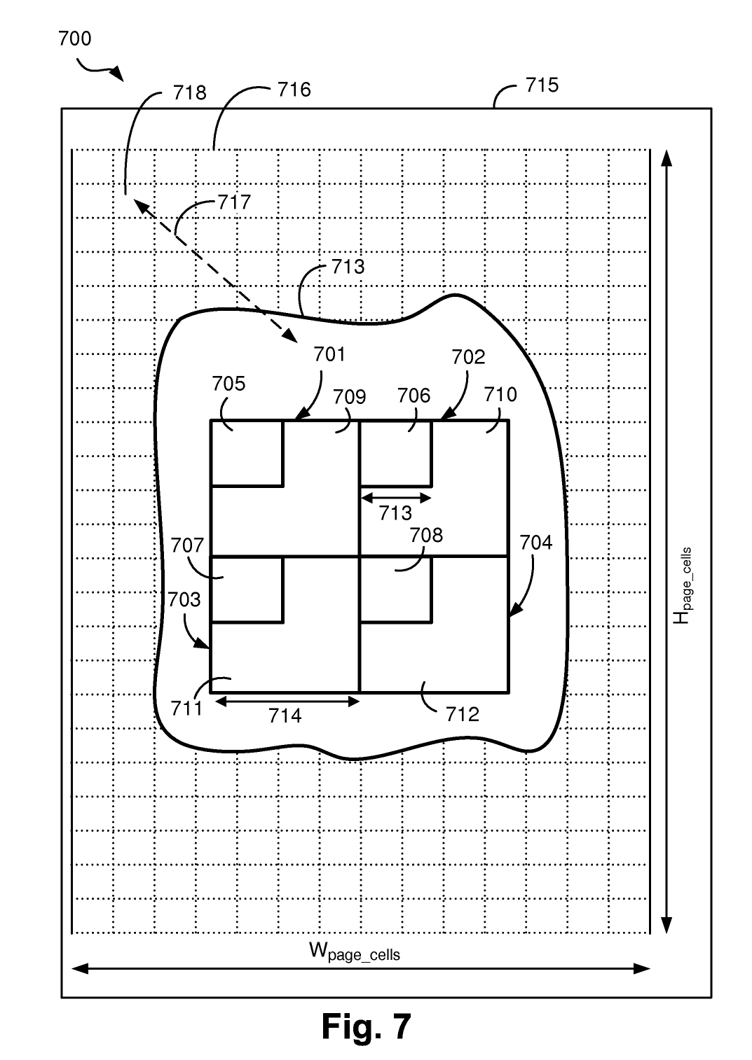

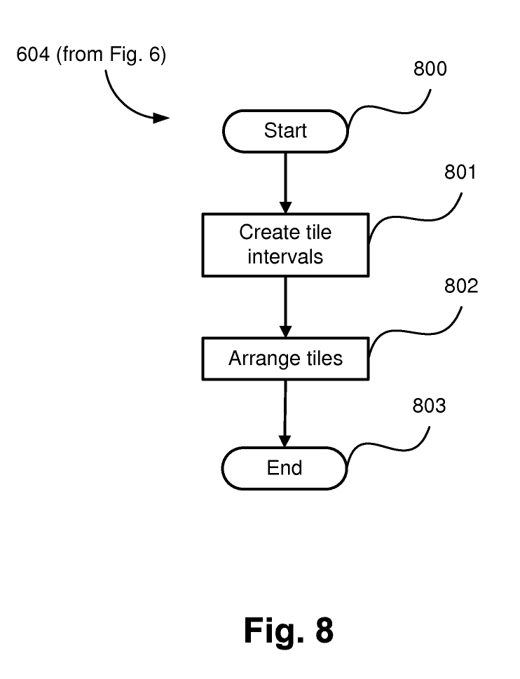

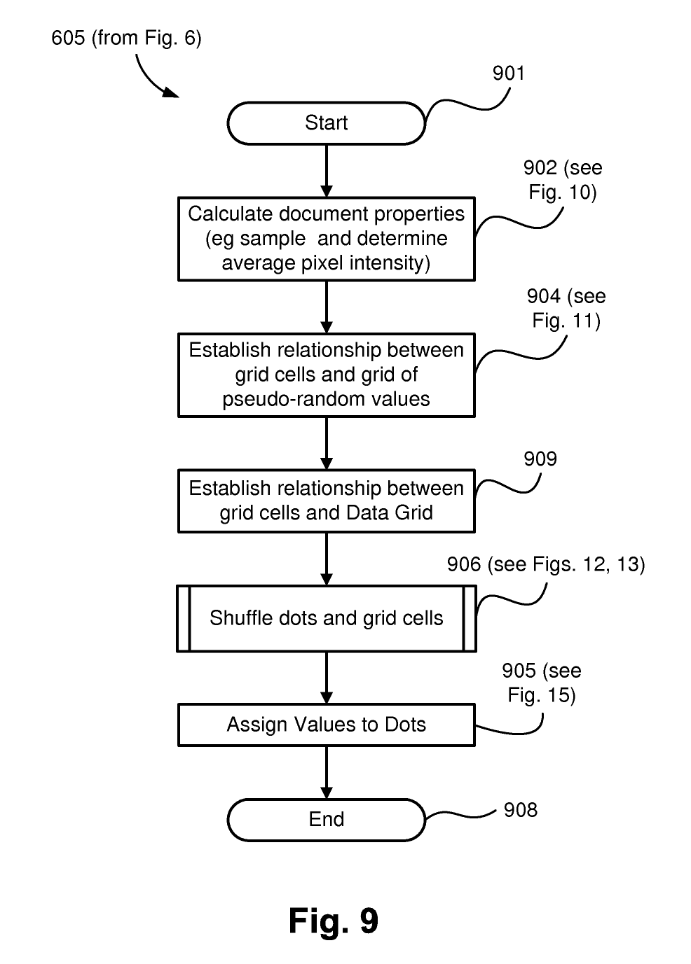

The SRDC method may be implemented using the computer system 100 wherein the processes of FIGS. 6, 8-9, 13, 16-18, 23, and 29, to be described, may be implemented as one or more software application programs 133 executable within the computer system 100. In particular, the steps of the SRDC method are effected by instructions 131 in the software 133 that are carried out within the computer system 100. The software instructions 131 may be formed as one or more code modules, each for performing one or more particular tasks. The software may also be divided into two separate parts, in which a first part and the corresponding code modules performs the SRDC methods and a second part and the corresponding code modules manage a user interface between the first part and the user.

The software 133 is generally loaded into the computer system 100 from a computer readable medium, and is then typically stored in the HDD 110, as illustrated in FIG. 1A, or the memory 106, after which the software 133 can be executed by the computer system 100. In some instances, the SRDC application programs 133 may be supplied to the user encoded on one or more CD-ROM 125 and read via the corresponding drive 112 prior to storage in the memory 110 or 106. Alternatively the SRDC software 133 may be read by the computer system 100 from the networks 120 or 122 or loaded into the computer system 100 from other computer readable media.

Computer readable storage media refers to any storage medium that participates in providing instructions and/or data to the computer system 100 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external of the computer module 101.

Examples of computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the SRDC application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the SRDC application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

A document to be protected using the SRDC approach as described below, may be stored in an electronic file of a file-system configured within the memory 106 or the hard disk drive 110 of the computer module 101, for example. Similarly, the data read from a security document may also be stored in the hard disk drive 110 or the memory 106 upon the security document being read. Alternatively, the document to be protected may be generated on-the-fly by a software application program resident on the hard disk drive 110 and being controlled in its execution by the processor 105. The data read from a security document may also be processed by such an application program.

The digital representation of the document to be protected may be acquired by scanning using the scanner 126. Similarly, the data read from a security document may be acquired using the scanner 126.

FIG. 1B is a detailed schematic block diagram of the processor 105 and a “memory” 134. The memory 134 represents a logical aggregation of all the memory devices (including the HDD 110 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106. A program permanently stored in a hardware device such as the ROM 149 is sometimes referred to as firmware. The POST program 150 examines hardware within the computer module 101 to ensure proper functioning, and typically checks the processor 105, the memory (109, 106), and a basic input-output systems software (BIOS) module 151, also typically stored in the ROM 149, for correct operation. Once the POST program 150 has run successfully, the BIOS 151 activates the hard disk drive 110. Activation of the hard disk drive 110 causes a bootstrap loader program 152 that is resident on the hard disk drive 110 to execute via the processor 105. This loads an operating system 153 into the RAM memory 106 upon which the operating system 153 commences operation. The operating system 153 is a system level application, executable by the processor 105, to fulfil various high level functions, including processor management, memory management, device management, storage management, software application interface, and generic user interface.

The operating system 153 manages the memory (109, 106) in order to ensure that each process or application running on the computer module 101 has sufficient memory in which to execute without colliding with memory allocated to another process. Furthermore, the different types of memory available in the system 100 must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

The processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal buses 141 functionally interconnect these functional modules. The processor 105 typically also has one or more interfaces 142 for communicating with external devices via the system bus 104, using a connection 118.

The SRDC application program 133 includes a sequence of instructions 131 that may include conditional branch and loop instructions. The program 133 may also include data 132 which is used in execution of the program 133. The instructions 131 and the data 132 are stored in memory locations 128-130 and 135-137 respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128-129.

In general, the processor 105 is given a set of instructions which are executed therein. The processor 105 then waits for a subsequent input, to which it reacts to by executing another set of instructions. Each input may be provided from one or more of a number of sources, including data generated by one or more of the input devices 102, 103, 126, 127, data received from an external source across one of the networks 120, 122, data retrieved from one of the storage devices 106, 109 or data retrieved from a storage medium 125 inserted into the corresponding reader 112. The execution of a set of the instructions may in some cases result in output of data. Execution may also involve storing data or variables to the memory 134.

The disclosed SRDC arrangements use input variables 154, that are stored in the memory 134 in corresponding memory locations 155-158. The SRDC arrangements produce output variables 161, that are stored in the memory 134 in corresponding memory locations 162-165. Intermediate variables may be stored in memory locations 159, 160, 166 and 167.

The register section 144-146, the arithmetic logic unit (ALU) 140, and the control unit 139 of the processor 105 work together to perform sequences of micro-operations needed to perform “fetch, decode, and execute” cycles for every instruction in the instruction set making up the program 133. Each fetch, decode, and execute cycle comprises:

(a) a fetch operation, which fetches or reads an instruction 131 from a memory location 128;

(b) a decode operation in which the control unit 139 determines which instruction has been fetched; and

(c) an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 6, 8-9, 13, 16-18, 23, and 29 is associated with one or more segments of the program 133, and is performed by the register section 144-147, the ALU 140, and the control unit 139 in the processor 105 working together to perform the fetch, decode, and execute cycles for every instruction in the instruction set for the noted segments of the program 133.

The SRDC method may alternatively be implemented in dedicated hardware such as one or more gate arrays and/or integrated circuits performing the SRDC functions or sub functions. Such dedicated hardware may also include graphic processors, digital signal processors, or one or more microprocessors and associated memories. If gate arrays are used, the process flow charts in FIGS. 6, 8-9, 13, 16-18, 23, and 29 can be converted to Hardware Description Language (HDL) form. This HDL description may be converted to a device level netlist which may be used by a Place and Route (P&L) tool to produce a file which can be downloaded to the gate array to program it with the design specified in the HDL description.

The term ‘protected document’ refers to a document with security features incorporated into the document that allow for protection of the document from attacks such as forgery, unauthorized copying or the like. Thus an original (unprotected) document (see (E) in 2902 in FIG. 29) is processed (ie encoded) according to the SRDC approach to produce the corresponding “original protected document” (see 2904 in FIG. 29). A protected document 2910 which is received and which is to be verified (ie decoded) using the SRDC approach is referred to as the “received protected document”. The received protected document 2910 is typically input 2911 to the scanner 126 which inputs 2907 scanned information derived from the document 2910 to the computer system 100 for verification. A received protected document such as 2910 in FIG. 29 that has been decoded (ie verified) according to the SRDC approach, is referred to as a “processed received protected document” (see 2912 in FIG. 29). Although the word “document” is used in the description, most of the examples shown depict single pages. This has been done for ease of description however the SRDC approach can be applied to multi-page documents on a per-page basis. The term “protected document” when used alone can refer either to the original protected document, or to the received protected document, and the intended meaning will be clear from the context.

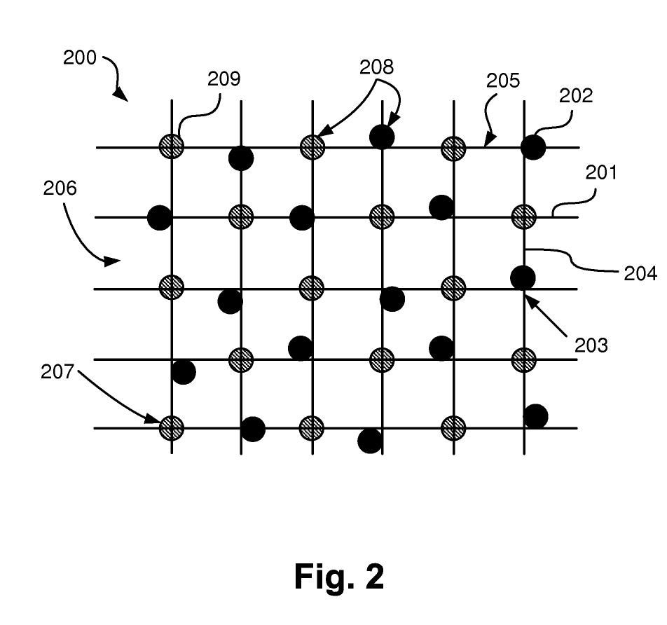

FIG. 2 provides an enlarged view of part of a protected document 200 according to the SRDC approach after security features have been incorporated into an unprotected document (not shown) by incorporating modulated protection marks on the unprotected document. Document protection is typically provided using a large number of dots 208 in an array 206.

The dots 208 in FIG. 2 are categorised into two different types. The first type of dot is referred to as an alignment dot 209 which lies on grid intersection points 203. The regular position of these alignment dots 209 helps establish a reference grid for determining the locations of the second type of dot. The second type of dot is referred to as a protection dot 202 or more generally as a protection mark.

Protection marks generally have a number of associated protection mark attributes including a position attribute, an intensity attribute, a shape attribute (also referred to as a symbol attribute) and so on. The described examples are based upon modulation of the position attribute. However, other modulation schemes (see (D) in 2902 in FIG. 29) can be used which relate to other attributes of the protection dots. Thus, for example, intensity modulation of the protection dots can be used, or alternately, code based modulation using different symbols (ie shapes) for the protection dots can be used.

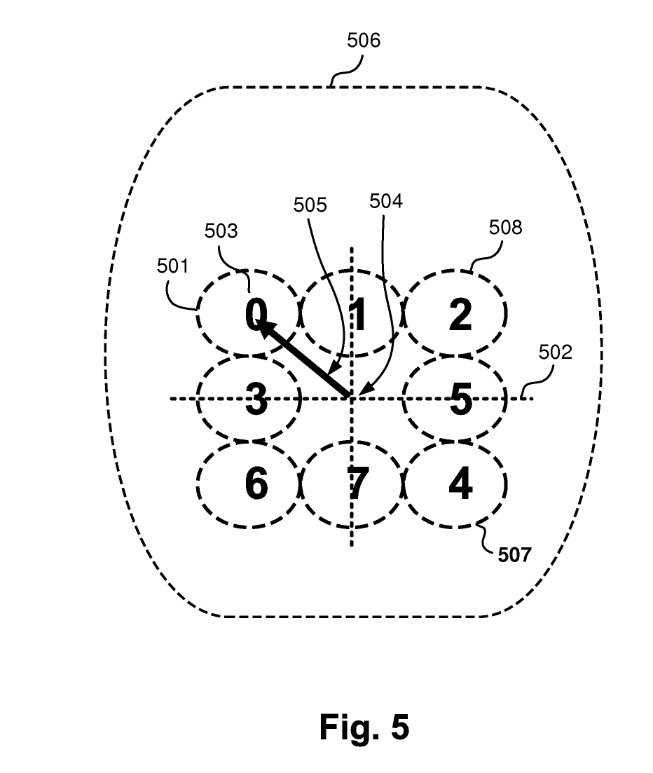

In position based modulation, different dot positions are used to denote the value to be associated with the protection dot in question. In the modulation scheme depicted in FIG. 5, for example, the various values of the protection dot shown range from 0-7, these values being associated on a one-to-one basis with respective spatial positions such as 501. In intensity based modulation, different dot intensities are used to denote different values of the protection dot in question. In code based modulation, different symbols are used to denote different values of the protection dot in question.

Each protection dot 202 is located in the vicinity of a corresponding grid intersection point 203 of the reference grid. In one SRDC arrangement the reference grid is a regular square grid 205 formed by horizontal lines 201 and vertical lines 204. It is noted that it is the protection dots 202 that provide the protection, and not the alignment dots such as 209 or the grid 205. The grid 205 is depicted purely to provide a frame of reference for describing the location of the alignment dots 209 and the protection dots 202, and accordingly the grid 205 may be considered to be a “virtual” grid.

A grid cell refers to a single grid intersection point (having a corresponding grid intersection point location coordinates) with (i) an associated protection dot, (ii) a series of associated values and (iii) an associated assigned value. Accordingly, a grid cell can be represented, in one SRDC arrangement, by the following data structure:

(x1,y1) grid intersection point location [1]

(a) assigned value [2]

(x3,y3) protection mark location [3]

(aa1, aa2, . . , aan) associated values [4]

where an “assigned value” is the value by which the protection dot is to be modulated, and an “associated value” is one of possibly a number of intermediary values which are used to calculate the assigned value and may include ancillary binary data.

The protection dot associated with a particular grid cell is directly observable on the protected document 200, meaning that the protection mark can be observed and measured directly and need not be derived from other properties of or information in the document. It is noted that the protection marks may be visible to a person (in order for example to announce that the document is protected and thus deter unauthorised amendments). However, the protection marks may also be invisible to a person, and yet are directly observable in that they are detectable (by the appropriate detection devices) and can be detected by a decoding system. The associated values and the assigned values are typically not directly observable on the protected document 200, but are merely associated with the grid cell in question. The associated values and the assigned values serve to describe the encoding/decoding processes.

Grid cells may be interchangeably viewed as either data structures which may be stored on a computer containing these values, or as physical entities on a page consisting of the grid intersection point together with (i) the associated protection dot, (ii) the series of associated values and (iii) an associated assigned value.

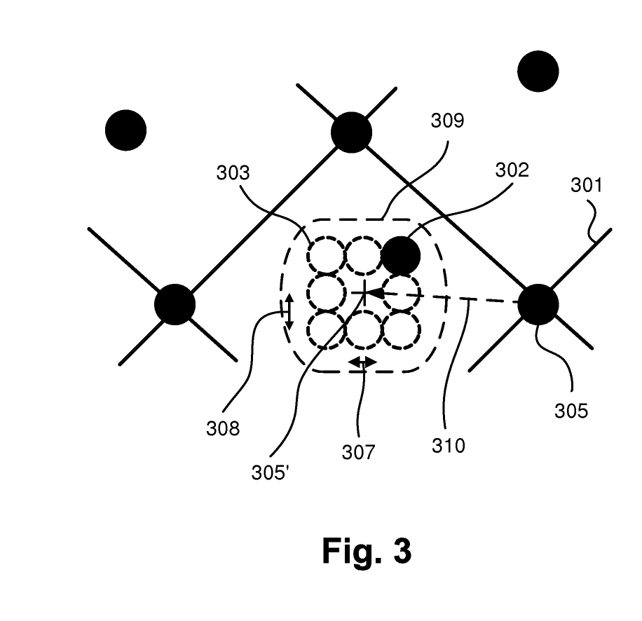

In use in the examples described, the positions of the protection dots 202 in the array 206 of protection dots are spatially modulated relative to their corresponding grid intersection points of the grid 205. The result of this modulation, having regard to a particular protection dot, is to move the protection dot (such as 302 in FIG. 3) to one of a number of positions (such as 303 in FIG. 3) which are at or in the vicinity of the corresponding grid intersection point 305. The appearance of the array 206 of modulated protection dots 202 is similar to that of a regular array of dots (ie an array of dots each of which is situated on the corresponding intersection point of an associated regular square grid), but not identical.

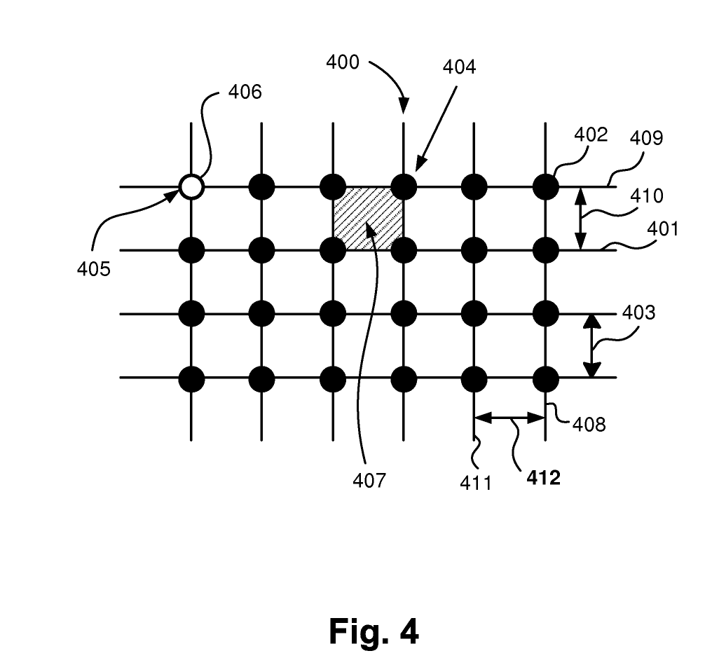

The example described with reference to FIG. 3 involves modulation of the position attribute of the unmodulated protection dot. As noted. other modulation schemes can be used which relate to other attributes of the protection dots. The term “unmodulated position” in this description is used in a number of related but different ways. Thus for example in FIG. 3 the central modulation position 306 is reserved solely for alignment dots. Accordingly, the unmodulated position for a protection dot in FIG. 3 would correspond to one of the eight locations such as 303 surrounding the central modulation position 306. In another example in FIG. 4, spatially unmodulated protection dots fall on the grid intersection points 405 of the associated reference grid 400. The appropriate unmodulated position is made clear by the details provided in each example.

FIG. 4 illustrates the initial (spatially unmodulated) positions for the protection dots which are to be applied, after suitable modulation, to a portion of a corresponding protected document. In the described arrangement, these initial positions form an unmodulated array of protection dots associated with the intersection points 405 of a regular square grid 400. The term “square grid” relates to the shape 407 that is described by horizontal lines 401 and vertical lines 408 of the grid 400. The grid 400 has a pitch 403 that is typically in the order of 1 mm. The distance 410 between two adjacent horizontal lines 409, 401 of the grid 400 is referred to as the vertical grid intersection point spacing. The distance 411 between two adjacent vertical lines 411, 408 of the grid 400 is referred to as the horizontal grid intersection point spacing. In square reference grids, the horizontal grid intersection point spacing is equal to the vertical grid intersection point spacing, and can be referred to simply as the grid intersection point spacing which is equal to the pitch 403 of the grid.

While the described arrangements make use of rectangular, and preferably square, regular grid arrangements, other grid arrangements are possible provided that the grid intersection points of the grid can be estimated. For example, grid arrangements having hexagonal or parallelogram grid shapes can be used. Furthermore, a grid formed by concentric circles and radii, which may be considered regular in terms of r and θ, can also be used. What is required is that the relative locations of the grid intersection points (ie the positions upon which or about which unmodulated protection marks are situated) be predefined in a known manner, thereby forming a basis for determining the positions of modulated protection marks depending upon the type of encoding used. Accordingly, once the grid 400, or the manner in which the grid 400 is formed, is known, then given the modulation scheme, the marks on an encoded protected document 200 may be decoded.

FIG. 6 is a flow chart of a process 600 for encoding an original unprotected document and thus generating the original protected document 200 according to the SRDC approach. The process 600 commences with a start step 601, after which a step 602 determines the initial (i.e. spatially unmodulated) positions for the protection dots 402 in the array 404, depicted in FIG. 4, thereby establishing an unmodulated grid. The spatially unmodulated positions correspond to the grid intersection points of the reference grid required, and this grid is generated using a set of grid generation rules (see (A) in 2902 in FIG. 29). In a simple case, these rules define a square reference grid with a pitch of 1 mm. This grid is depicted by 716 in regard to a document 715 shown in FIG. 7.

In a subsequent step 603 the protection dots 402 are separated (ie allocated) into two separate “channels” where the term “channel” is used to denote the fact that each channel can carry a certain amount of information (see (B) in 2902 in FIG. 29). Although two channels are used in one SRDC arrangement according to the particular set of rules used, it will be appreciated that this does not have to be the case, and more than two channels can be defined using the protection dots 402.

In one SRDC example the first channel consists of a first pattern of protection dots that are not available to the second channel. In other words, the protection dots used for the first channel are distinct from the protection dots used for the second channel. This first channel contains a first security feature, and the protection dots 402 belonging to the first channel are disposed on the document 715 in a regular or otherwise predictable pattern, this allowing the location of the protection marks 402 to be predicted. The protection dots 402 belonging to the first channel can be located in an area of the page 715 in which the protection dots 402 are obfuscated (ie rendered difficult to interpret) by page content such as printed images in some known fashion. For example, a document may contain a number of full colour images which will obfuscate dots of the first channel. If the locations of these images are known to both the encoding and decoding sides of the process then the pattern by which the protection dots are disposed may be deduced from the pattern of dot loss.

In this SRDC example the first channel encodes a first security feature that takes the form of a repeating tiled pattern each pattern being used to store an identical message (referred to elsewhere as an LDD Message). This results in a redundantly stored message that is repeated across the protected document.

The second channel consists of a second pattern of protection dots that encodes a second security feature that encodes information about the information content of the original document. The protection dots 402 of the second channel, and the document content which is the subject of the second security feature, are located in distinct respective areas of the document whose relative locations are defined by a predefined spatial relationship. The second channel encodes a second security feature that takes the form of a repeating tiled pattern.

FIG. 7 shows one possible spatial arrangement for the two channels as defined by pre-determined rules (see (B) in 2902 in FIG. 29). A fragment 713 of the document 715 is shown having a repeating pattern of large tiles such as 711 each contain a smaller tile such as 707 in a tiled grid structure 716 across the page 715.

Another way of looking at the tiled arrangement is as a repeating pattern (ie set) of points (this pattern corresponding to the large tiles), where each member of the repeating pattern comprises two subsets of points (where the two subsets correspond, having regard to a particular large tile containing a small tile, to the points in the small tile and the residual points in the large tile) having a predefined spatial relationship, said subsets of points being associated with corresponding regions of the document.

One such tile 701 and the corresponding representation 718 in the tiled grid structure 717 is depicted by a dashed arrow 717. As will be described below, a first channel which encodes a first security feature comprises protection dots in the repeating pattern of the small tiles such as 707. Each small tile contains an identically modulated set of protection dots which make up the first channel and the first security feature. The second channel which encodes a second security feature comprises protection dots in the repeating pattern formed by the residual area of each large tile after excluding the small tile contained in each large tile. Each of the aforementioned residual areas associated with the second security feature contain a modulated set of protection dots which make up the second channel and the second security feature.

In one example the first security feature is a code which can be recognized by a suitably equipped photocopier which disables the copying function of the photocopier upon detection of the first security feature unless a suitable password is manually entered into the photocopier keypad. The second security feature contains protection dots which relate to the information content of both the residual areas of the large tiles and to the information content of the small tiles. In this example, the first security feature is related to the prevention of unauthorised copying of the document of which 713 is a fragment. The second security feature is related to anti-tamper capability, ie prevention of tampering to the document, and performs this function both in relation to tampering with the information content of the small tiles such as 707, and tampering with the information content in the residual areas of the large tiles such as 711.

The predefined relative spatial relationship between the small tiles and the residual areas of the large tiles is depicted by the predefined geometric relationships between these areas on the fragment 713 of the page shown in FIG. 7.

Returning to a more detailed description of FIG. 7, each tile 701, 702, 703 and 704 (which are representative of a tile pattern which continues across the grid 400) can be considered to contain two separate data channels, namely a first Low Data Density channel (herein referred to as the ‘LDD Channel’ such as 705) and a second High Data Density Channel (herein referred to as the ‘HDD Channel’ such as 709). The tiles 701-704 are tiled across the page 715 to form the tiled grid structure 716 of dimensions W_{page}_{_{—}}_{cells}×H_{page}_{_{—}}_{cells} where W_{page}_{_{—}}_{cells} is the width of the tiled grid structure in units of grid cells, and H_{page}_{_{—}}_{cells} is the height of the tiled grid structure in units of grid cells. The aforementioned spacing in units of grid cells means that the spacing is defined in units of grid intersection point spacing, for the particular grid being considered.

Examples 700 of the LDD channel tiles shown in FIG. 7 are referenced as 705, 706, 707 and 708. LDD channel tiles have dimensions as indicated at 713 (herein referred to as the ‘LDD tile size’), in units of grid cells.

The LDD channel tiles are tiled redundantly across the grid 400 at a spacing of HDD tile spacing 714, also in units of grid cells. The LDD channel tiles are embedded in the HDD channel tiles 709, 710, 711 and 712. The HDD channel tiles 709, 710, 711 and 712 have dimensions of HDD tile size as indicated at 714, and are tiled redundantly across the grid at a spacing of HDD tile size. The term “tiled redundantly” (in regard to LDD tiles, as HDD tiles are not tiled), means that each tile contains the same protection information comprising a set of identically modulated protection dots.

Areas 709, 710, 711 and 712 constitute the HDD channel, which is present across the grid 400 on the fragment 713 of the page in question. The HDD channel consists of areas in the tiles which are not designated as LDD channel tiles 705, 706, 707 and 708. Grid cells which fall within the LDD channel area are classified as belonging to the LDD channel and are referred to herein as LDD channel grid cells or first channel grid cells. Likewise, grid cells which fall within the HDD channel area are classified as belonging to the HDD channel and are referred to herein as HDD channel grid cells or second channel grid cells.

Although the illustrated tiles are of a specific shape (ie square in the present example), other shapes can be utilised for the HDD or LDD channels, provided a suitable pre-defined regular or otherwise predictable geometric arrangement can be formulated.

Returning to FIG. 6, in a subsequent step, 604, values are assigned to the first channel grid cells. This step is further detailed in the process 800, illustrated in FIG. 8.

FIG. 8 shows how the process 604 commences with a step 800 and in a subsequent step 801, values for the LDD channel tile are calculated. The values are based on an LDD message (also referred to as the first security feature) which is to be encoded in the LDD channel (see (C) in 2902 in FIG. 29) of the unprotected document. This message is usually of high importance, taking advantage of the fact that due to the high redundancy of the LDD channel, the LDD message will likely survive even with considerable damage to the protected document.

Error Correction Codes (ECCs) such as Reed-Solomon or Low Density Parity Check (LDPC) can be used during encoding of the LDD message into the document in question. ECCs are used in digital communication systems to overcome channel errors introduced between the encoding and decoding stages. Utilisation of a strong ECC can make the protection content associated with a set of protection marks highly robust against errors which may otherwise be introduced by folding, wrinkling, staining, tearing and defacement of the document carrying the protection content. LDPC is used during encoding, due to its iterative error correction properties.

Using ECC during encoding is optional to the encoding process, but is used in the first SRDC arrangement. To use ECC during encoding, ECC encoding is applied to the original LDD message to obtain a final coded LDD message.

The coded LDD message is then converted into 3 bit digital code values (also referred to as “intervals”). This involves dividing the final coded LDD message into groups of 3 bits and converting each 3 bit group into its corresponding digital code value. While 3 bits are used in the first SRDC arrangement, a simple extension is to use a modulation scheme with more or less than 8 values, and hence a different number of bits per interval.

In a subsequent step 802 the one dimensional array of intervals is arranged in a 2-dimensional array of size LDD tile size by LDD tile size, which is tiled across the grid 716 with a spacing of HDD tile size into the tiled LDD Channel tile areas defined in step 603 and the interval values become the values assigned to their corresponding grid cells. The process is then completed at 803. In other words, the successive intervals (ie the digital code values) associated with each successive group of 3 bits in the coded LDD message are used as the values for the successive protection dots which are mapped and encoded, according to the predefined modulation scheme (see (D) in 2902 in FIG. 29) to various spatial modulation positions for the successive protection dots in a 2D array across each LDD tile in the grid 716. The entire LDD message is encoded to each successive LDD tile. This results in a partially protected document, as only one of the two security features has been encoded onto the unprotected document.

The first security feature can be used, as noted above, as a means of preventing unauthorized copying of the document in question by suitably equipped photocopiers which are capable of decoding the first security feature when the document is placed on the copier platen for copying.

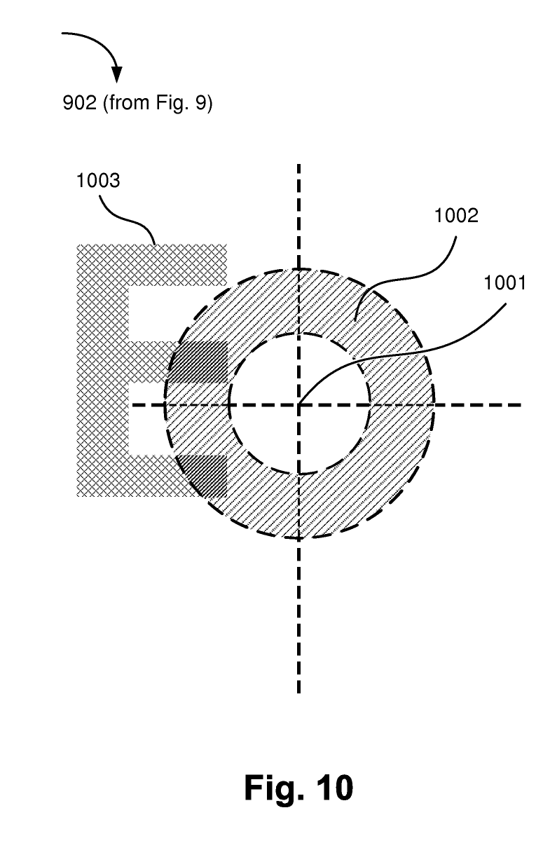

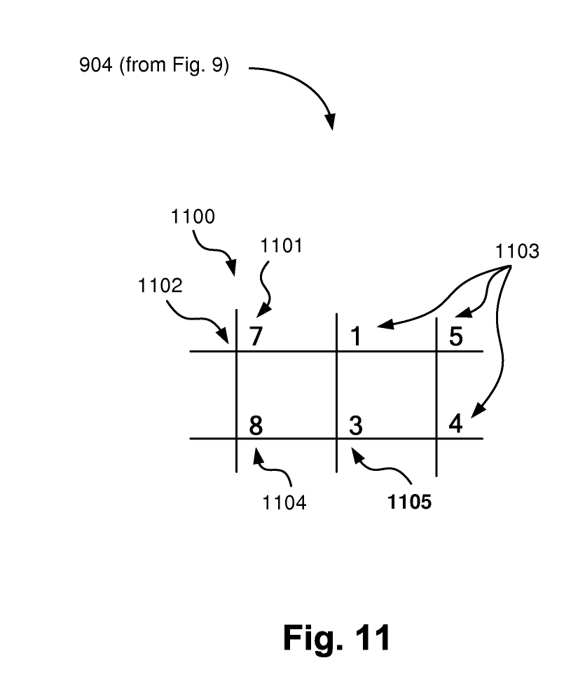

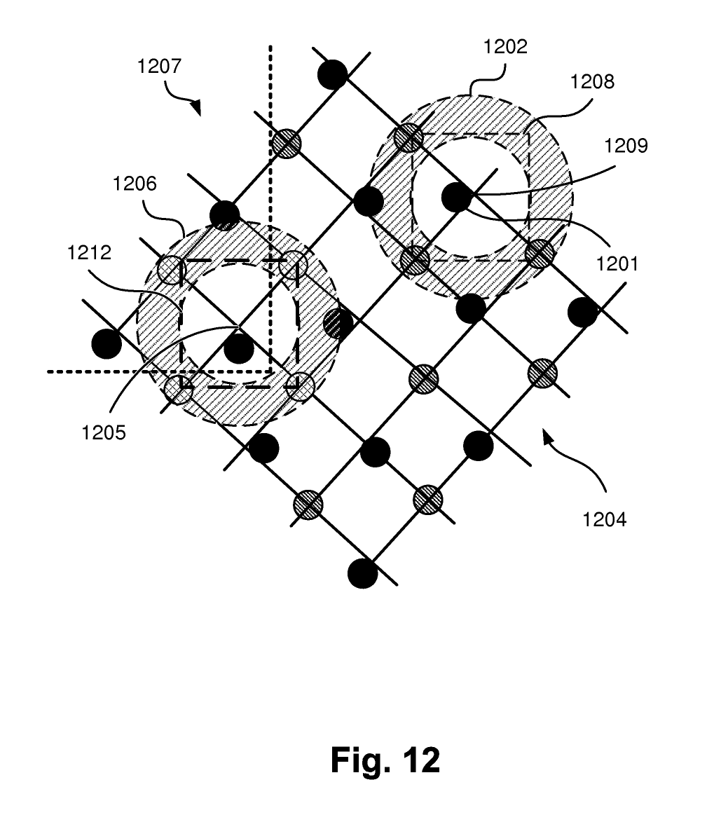

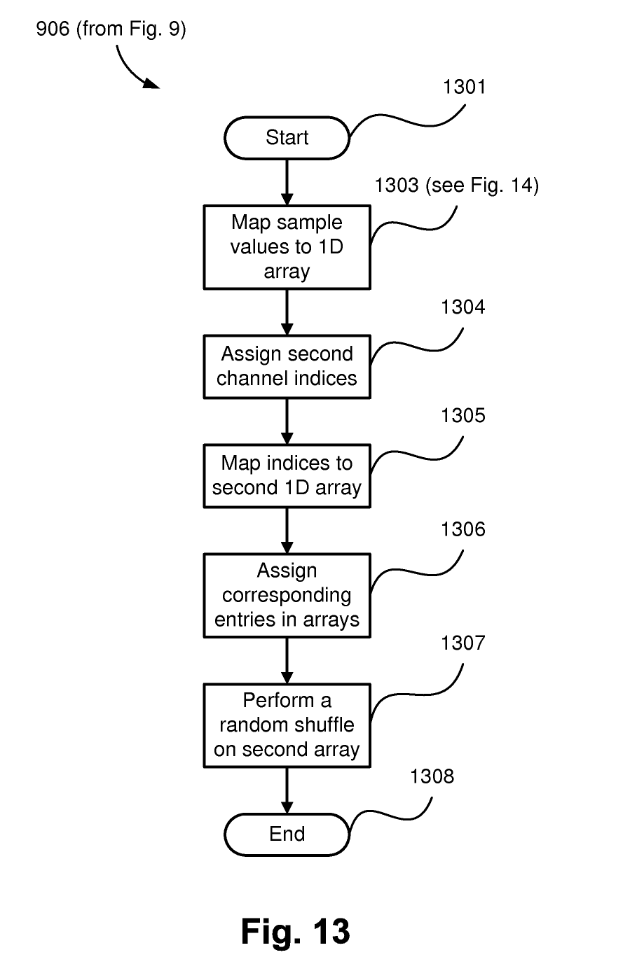

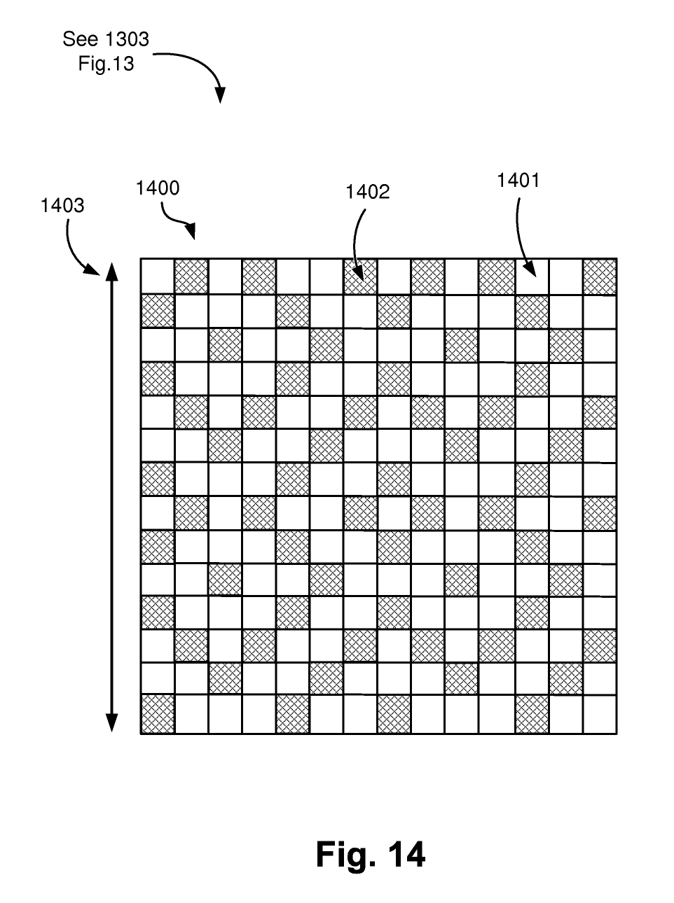

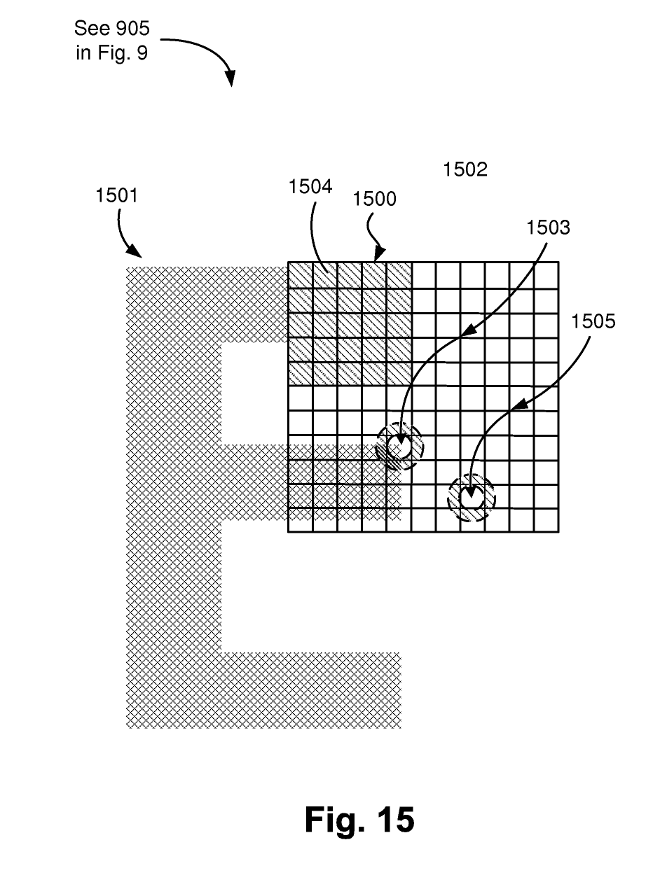

Returning to FIG. 6, in a subsequent step 605, values are associated with the remaining grid cells (i.e. the second channel grid cells) whose protection dots constitute the second security feature. This process is further detailed in FIG. 9.

FIG. 9 shows how the process 605 begins at a step 901 and in a subsequent step 902, the properties of the page 715 to be encoded in the second channel are determined In the first SRDC arrangement, the second channel provides tamper protection for the original unprotected document, and each of the protection dots in the second channel encodes some property of the original information content on the original unprotected document for comparison with the corresponding property of the received protected document upon decoding.

One such property, and the property used in the first SRDC arrangement is based on average intensity in an area of the document in question and is described below with reference to FIG. 10.

FIG. 10 shows, with reference to the original unprotected document (see (E) in 2902 in FIG. 29), a typical area used to calculate the average pixel intensity. The original unprotected document is first converted to a greyscale image. The greyscale bitmap image is then binarised to form a black and white image in the following manner. First a filter function is applied to the greyscale image, such as Gaussian blur. The blurred greyscale image is then binarised, by applying a threshold function, to form a black and white image.

The average pixel intensity of an annular area 1002 around each grid intersection point 1001, i.e. the grid sampling area, is then determined across the entire partially protected document 715, for both LDD grid cells and HDD grid cells. Ideally the area 1002 overlaps with corresponding grid sampling areas around other grid intersection points. In the present example, the grid sampling area 1002 encompasses part of a letter ‘E’ 1003. The average pixel intensity is determined for the grid sampling area 1002, and this average pixel intensity is scaled, using a suitable scale factor (see (F) in 2902 in FIG. 29), to one of the possible protection dot values. The aforementioned scaled value constitutes the image data value associated with the grid cell. This image data value represents the information content of the original document associated with the grid sampling area.

In regard to the example in FIG. 10, the property of the unprotected document that is used is the average pixel intensity, and the area to be used is the grid sampling area 1002. However other properties and other areas can also be used. For example, the grid sampling area can be circular, square, or any shape, or the union of a plurality of small areas in any shape. Other properties which can be used include different statistical measures of the pixel intensity, e.g. the median, maximum or standard deviation. By using a Fourier transform of the area, other properties such as the median frequency, centroid or peak positions can be used. Another property which can be used is the average direction of the lines in the area.

The average pixel intensity sampled around each grid intersection point becomes the associated image data value for the grid cell to which that grid intersection point belongs.

The average pixel intensity sampled around each grid intersection point is thus information which is used to modulate protection dots in the second channel in order to encode the selected property (ie average pixel intensity) of the original information content on the original unprotected document for comparison with the corresponding property of the received protected document upon decoding.

Returning to FIG. 9, a pseudo-random value is then associated with each grid cell in a following step 904. A 2D array 1100 of pseudo-random values 1103 (see FIG. 11 which shows a fragment of the array 1100) having a range of 0 to 7 (or when using some modulation scheme other than that suggested in FIG. 5, 0 to the maximum value encodable in the modulation scheme) and some predetermined size W_{rg}×H_{rg} (see (G) in 2902 in FIG. 29) is generated from a seed (see (H) in 2902 in FIG. 29) known to both the encoder (see (H) and 2900 in FIG. 29) and the decoder (see (A) and 3000 in FIG. 30). W_{rg} is the width of the array 1100 in units of grid cells, and H_{rg} is the height of the array 1100 in units of grid cells.

In the first SRDC arrangement, the dimensions in units of grid cells of the 2D array 1100 of pseudo-random values W_{rg}×H_{rg} are larger than the likely max dimensions of the tiled grid structure 716 in FIG. 7, which is W_{page}_{_{—}}_{cells}×H_{page}_{_{—}}_{cells}, in units of cells. However a smaller array of pseudo-random values may also be used. Dimension values for the 2D array used in the first described arrangement are as follows:

W_{rg}=600 grid cell units [5]

H_{rg}=600 grid cell units [6]

As noted in regard to FIG. 4, a typical pitch of the grid 400 (or alternately the grid 716 in FIG. 7) is 1 mm. The typical size of an original document such as 715 in FIG. 7 is A4 or A3, indicating respective sizes of 210×297 grid cell units, and 297×420 grid cell units.

Arbitrary offsets in grid cell units in the x and y directions —X_{offset} and Y_{offset} offset respectively (see (I) in FIG. 29) are chosen and each grid cell in the grid 716 at grid co-ordinates X_{dg} and Y_{dg} is associated with a value in the array 1100 of pseudo-random values 1103 at co-ordinates (X_{dg}+X_{offset},Y_{dg}+Y_{offset}). The offsets X_{offset} and Y_{offset} may be greater than W_{rg}−W_{page}_{_{—}}_{cells} and H_{rg}−H_{page}_{_{—}}_{cells} respectively or may even be negative. In such cases the page 715 (or rather the grid 716) wraps around the 2D array of pseudo-random numbers.

Returning to FIG. 9, in a following step 909, a data value (ie an associated value as referred to in [4]) is then associated with each of the grid cells. This takes advantage of the fact that an ancillary capability of the second channel is to enable embedding of ancillary binary data into the HDD channel, in addition to the information used to detect tampering. This ancillary data may be any data and is not necessarily related to the information content of the document. One method of doing this is to reserve two modulation positions (eg modulation positions 501 and 508 in FIG. 5) for encoding a digital code value of 0. These two modulation positions both represent an average pixel intensity of 0, but they represent data values of 0 and 1 respectively. The data to be embedded—which will likely be a string of binary values or at least easily converted to such—can then be split up into individual bits, and associated with protection dots as data values. In this way, white areas of the page (those with digital code value 0) are used to encode the data values. The data values can be repeated across the page, and error correction codes used to improve robustness. In this step, a single bit value constituting part of the data values are associated with each grid cell that is associated with an image data value of 0. One way to repeat the data values across the page would be to use a similar method to that used to distribute the pseudo-random values across the page i.e. tiling the bit values across a 600×600 grid, possibly with error correction, and then associating them with grid cells.

In a following step 906, the values associated with the grid cells (ie the values [1]-[4]) are shuffled so as to be associated with new protection dots. This step is explained in further detail with reference to FIG. 12.

FIG. 12 depicts a fragment 1204 of an HDD (ie second) channel (eg see 709 in FIG. 7) and a fragment 1207 of an LDD (ie first) channel (eg see 705 in FIG. 7). It is seen how a grid cell 1208, as earlier described in relation to FIG. 2, consists of a protection dot 1201, and a grid intersection point 1209. Other information consisting of some or all of an image data value, a pseudo-random data value and a data value are also associated with the grid cell 1208. An assigned value associated with the grid cell 1208 defines how the protection dot is modulated.

Although each grid cell has its own grid intersection point, there is no need for a grid cell's associated image data value be the image data value which is sampled around its own grid intersection point 1202. In fact, it is advantageous in some applications that the image data value associated with a grid cell in the second channel area 1204 be the image data value 1206 sampled around some other grid intersection 1205 in the first channel area 1207. In the example in FIG. 12, the image data value sampled from 1206 taken at the grid intersection point 1205 (which is, in the first instance, apparently associated with a grid cell in the first channel 1207) is in fact associated with the grid cell 1208 according to one SRDC arrangement.

A number of methods for choosing which image data value is associated with a grid cell can be used. The first SRDC arrangement employs a shuffling technique to pseudo-randomly re-associate the information associated with each grid cell to another grid cell. In this SRDC arrangement, relationships between image data values, pseudo-random data values and data values are maintained, so all these three values [2]-[4] are shuffled together to be thus associated with the same new grid cell. FIG. 13 illustrates this process.

FIG. 13 shows the process 906 which commences at a step 1301 and then proceeds to a following step 1303 which extracts the associated values (defined by equations [1]-[4]) at each grid cell of interest within a tile, in both the first channel area and second channel area.

The term ‘of interest’ is used to indicate the fact that generally not all of the values associated with grid cells can be encoded. In the present example this is because there are (HDD tile size²) tile size grid intersection points per tile and only (HDD tile size²−LDD tile size²) available encodable grid intersection points. In other words, the number of encoding cells per tile is limited to total grid cells in a HDD tile[HDD tile size² where an example of HHD tile size is depicted by 714 in FIG. 7] minus first channel grid cells in a tile [ie LDD tile size² where an example of LDD tile size is depicted by 713 in FIG. 7] and this is the number of available protection marks for encoding, provided that only one sample is to be encoded in a single grid cell. In one arrangement the second channel encodes a second security feature that encodes information about the information content of the original document. The fact that the number of grid cells of interest in a document (ie the number of available encoding grid cells) is less than the total number of grid cells spanning the document means that the second security feature encodes information about the information content of the original document on a statistical basis. An example of this is depicted in FIG. 14.

FIG. 14 shows (see (J) in 2902 in FIG. 29) a suitable pattern 1400 of grid cells of interest such as 1401 (depicted as white grid squares) to be encoded, and also shows those grid cells 1402 not to be encoded (depicted as cross hatched grid squares).

It will be appreciated that the pattern 1400 in FIG. 14 is of dimensions HDD tile size 1403 by HDD tile size 1403 and covers all the grid cells in both the HDD tile and the associated LDD tile. This pattern 1400 should preferably define grid cells in an even fashion across the pattern 1400, with the definition of ‘even’ depending on the problem being addressed since this goes to the statistical nature of the security feature associated with the second security feature. In the first SRDC arrangement, the maximum selectable number of grid cells of interest is determined as described earlier. A pattern is then chosen so that the average minimum distance from one encoded grid cell to another is maximised (with distances conceptually wrapping around the tile) when this number of grid cells are chosen for encoding. This effectively means that the spacing between the locations where the average pixel intensity is sampled is also maximized. The values of the grid cells selected are then arranged in some suitable fashion into a first 1D array, herein referred to as an associated value array. This generates a 1D array of length encoding cells per tile (where the “tile” referred to in this instance is the tile 701 in FIG. 7).

A following step 1304 assigns a unique index value to each grid cell in the second channel area of the tile, and these unique indices are arranged into a second 1D array, herein referred to as the tile index array, in a following step 1305. This generates a 1D array of length encoding cells per tile.

In a following step 1306, a relationship is established between the two arrays, such that the 0th entry of the associated value array is related to the 0^{th} entry of the tile index array, the 1^{st} entry of the associated value array is related to the 1^{st} entry of the tile index array, and so on. A pseudo-random shuffle, such as a basic Knuth Shuffle is then applied to the tile index array in a following step 1307. The entries of the associated value array maintain their relationship with the positions of the tile index array, and not the entries originally contained at those indices. In this way, each grid cell in the second channel of the tile (identified by its index in the tile index array) is pseudo-randomly associated with the associated values from one of the grid cells of interest (i.e. the associated value in the associated value array). The value re-associated with each second channel grid cell is found by taking the original index assigned to the grid cell, finding it in the tile index array and taking the related value in the associated value array.

The assigned value is calculated as the sum of the associated values in the related associated value array. The modulus 8 of the re-associated value is taken in the case that the number of possible modulation positions is 8. In other SRDC arrangements, where the number of possible modulation positions in the dot modulation scheme is n, modulus n+1 is taken.

This re-association method based, in the present example, on the shuffle performed in the step 1307, affords a number of advantages. Firstly, as the associated values from a grid cell belonging to either a first channel or second channel grid cell may be re-associated with a grid cell in the second channel, information is encoded about regions of the document which are inside both first channel or second channel areas i.e. information is sampled from grid points in both the LDD Region 705 and the HDD Region 709. This means that there is no bias in terms of protection to either the first channel or second channel areas. Secondly, as the re-association of values is pseudo-random, it is less likely that burst noise resulting in the destruction of a number of protection dots in close spatial relationship will result in a loss of samples in close spatial relationship. Thirdly, as protection dots are easily obscured by foreground feature areas, it is preferable that protection dots which are encoding information about such important areas are spatially disjoint from the areas i.e. dot and encoding area pairs are chosen so then they are not close to one another within the tile, while the SRDC arrangement maintains the correspondence between the protection dots and the associated areas.

Returning to FIG. 9 in a following step 905, an iterative process is applied in which a decision is made in regard to each grid cell belonging to the HDD Channel in order to determine whether one or more of the associated values [4] can be defined as the assigned value [1] of the grid cell in question. For each of these grid cells, a decision is made whether to incorporate the associated value based on some property, for example, of the grid cells location in a tile 701 or some property of the values associated with the cell. In the first SRDC arrangement, the latter approach is employed as depicted in an example in FIG. 15.

FIG. 15 illustrates a scheme for selecting ancillary data dots. In the first SRDC arrangement, any grid cells which are associated with an image data value close to zero, such as depicted by 1505, are designated as data carrying cells. All remaining grid cells in the second channel are assigned image data values sampled from foreground areas such as 1503 of the document, and are designated as non-data carrying cells 1503. Neither of these types of cells are selected from the LDD region 1504 of the tile as all LDD channel grid cells are used to encode LDD channel information.

Accordingly, for each grid cell in the second channel, if the grid cell is a data carrying cell then the assigned value [2] is the associated ancillary data value [4], plus its associated pseudo-random value and its sampled image value. In contrast, for a non-data carrying cell the assigned value [2] is the sum of the associated pseudo-random data value and the associated sampled image value of the current grid cell. The modulus 8 of each assigned value is then taken. In some SRDC arrangements which use a modulation scheme with a number of modulation positions other than 8, the modulus n of the assigned value is taken, where there are n possible modulation positions. This process continues until there are no more grid cells in the second channel to be processed. The process 900 then terminates at 908.

Returning to FIG. 6, the process 600 then proceeds to a following step 607 where each protection dot is modulated by its assigned value. As mentioned earlier, the first SRDC arrangement uses 3 bit modulation or 8 different modulation positions. However, 4-bit, 5-bit or higher modulation schemes may be used depending on the grid cell spacing and quality of equipment used to perform encoding and decoding.

FIG. 3 illustrates one example of modulation of the protection dots. A grid intersection point 305 is shown in magnified form in a dashed inset 309, as depicted by a dashed arrow 310. A spatially modulated protection dot 302 lies close to or upon the grid intersection point 305 (referred to as 305′ in the magnified inset 309) of a grid 301. The dot 302 is spatially modulated to one of eight possible positions such as 303. The set of possible modulation positions is encompassed by the dashed outline 309. The spatial modulation, performed by translating the protection dot 302 in a lateral 307 and/or transverse 308 direction relative to the corresponding grid intersection point 305′, encodes data in the modulated protection dot. In other words, the value of the protection dot is mapped to one of the positions shown in FIG. 3 based upon a predetermined modulation scheme (see (D) in 2902 in FIG. 29).

The grid 301 is, in the example shown, regular in the sense that it is definable and machine detectable and forms a set of reference locations (i.e. intersection points 305) in regard to which modulation may be imposed upon corresponding protection marks. As per the example illustrated in FIG. 3, the eight possible modulation positions 309 for each protection dot are arranged in a three by three modulation position array centred on the corresponding grid intersection point 305′. The central modulation position 305′ of the three by three (3×3) array of modulation positions 309 is located at the grid intersection point 305, and corresponds to a modulation of zero distance horizontally 307 and zero distance vertically 308. This position is reserved solely, in one SRDC arrangement, for grid alignment dots. The remaining eight modulation positions are offset from the grid intersection point 305′ horizontally, vertically, or both horizontally and vertically. Protection dots use these remaining 8 modulation positions.

The regular grid 301 may be conceptually viewed as a “carrier” signal for the modulated protection dots and, like a carrier wave in radio frequency communication, is not directly observable. The horizontal and vertical distance by which the modulation positions are offset from the grid intersection point 305′ is referred to as a modulation quantum 304, herein abbreviated as “mq”. The locations of the eight modulation positions such as 303, relative to the corresponding grid intersection point 305′, can be defined as a list of (x, y) vectors where x indicates the horizontal direction 307 and y indicates the vertical direction 308. Using the convention that rightward offsets 307 are positive with respect to x and downward offsets (ie opposite to 308) are positive with respect to y. The vectors are represented by the following set of values:

$$\begin{matrix}( - mq , - mq ) , \\ ( 0 , - mq ) , \\ ( + mq , - mq ) , \\ ( - mq , + 0 ) , \\ ( + mq , + 0 ) , \\ ( - mq , + mq ) , \\ ( 0 , + mq ) , and \\ ( + mq , + mq ) & [ 7 ]\end{matrix}$$

FIG. 5 shows modulation positions as depicted in FIG. 3 in more detail. In FIG. 5, a set 506 of modulation positions is centred on a grid intersection point 504 of a grid 502. Each modulation position, such as position 501, has an associated digital code value 503. The digital code value 503 for the position 501 is “0”. The eight modulation positions allow each protection dot to encode one of eight possible digital code values (including the value 503 for the position 501). Each modulation position may equivalently be represented as a vector 505.

The above described arrangement uses an base-eight modulation scheme with a three by three (3×3) array of modulation positions. Alternate modulation schemes with a smaller or larger number of modulation positions can also be used. These alternate schemes can include base-4 (2×2), base-16 (4×4), base-25 (5×5), base-36 (6×6), base-49 (7×7), and so on. Modulation schemes based upon rectangular grids can also be used. For example, base-6 (2×3), base-12 (3×4), base-20 (4×5), base-30 (5×6), and base-42 (6×7) may be used if desired.

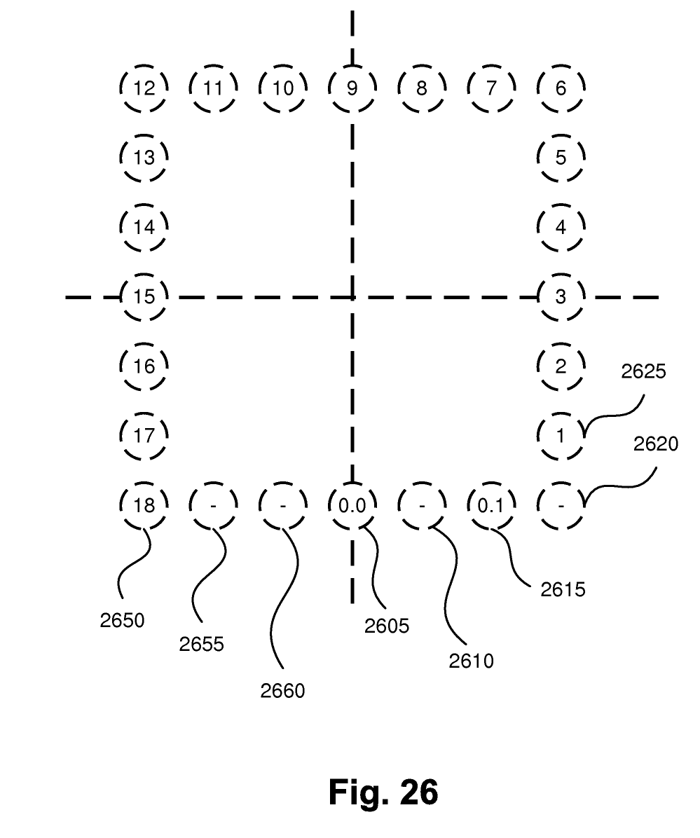

Modulation schemes of other shapes (e.g. circular) can also be used. Another alternative is shown in FIG. 26 where a base 19 modulation scheme is used to encode data. In this arrangement modulation positions 2605 and 2615 are both used to encode a value of zero. The values “one” (associated with a modulation position 2625) to “eighteen” (associated with a modulation position 2650) are encoded in an anticlockwise direction. The distance between some encoded values, such as zero (ie 2605) and eighteen (ie 2650), can be increased by not assigning values to modulation positions 2655 and 2660. Similarly no value is assigned to modulation positions 2610 and 2620.

Each protection dot, both in the first channel and the second channel is modulated according to the above scheme based on the assigned values [2] determined in steps 604 and 606 of the process 600 depicted in FIG. 6. The dots are then incorporated into the data comprising the protected document 200 (also depicted as 715 in FIG. 7) that is directed as depicted by an arrow 2904 to the printer 115 and output as the protected document (ee 2904 in FIG. 29).

### Verifying Protected Documents

The purpose of encoding a protected document as described above is so that when the protected document is scanned by a scanner 126, a verification step may be performed which validates the originality of the protected document, prohibits further reproduction of the protected document, provides evidence of tampering of the protected document or some other security function.

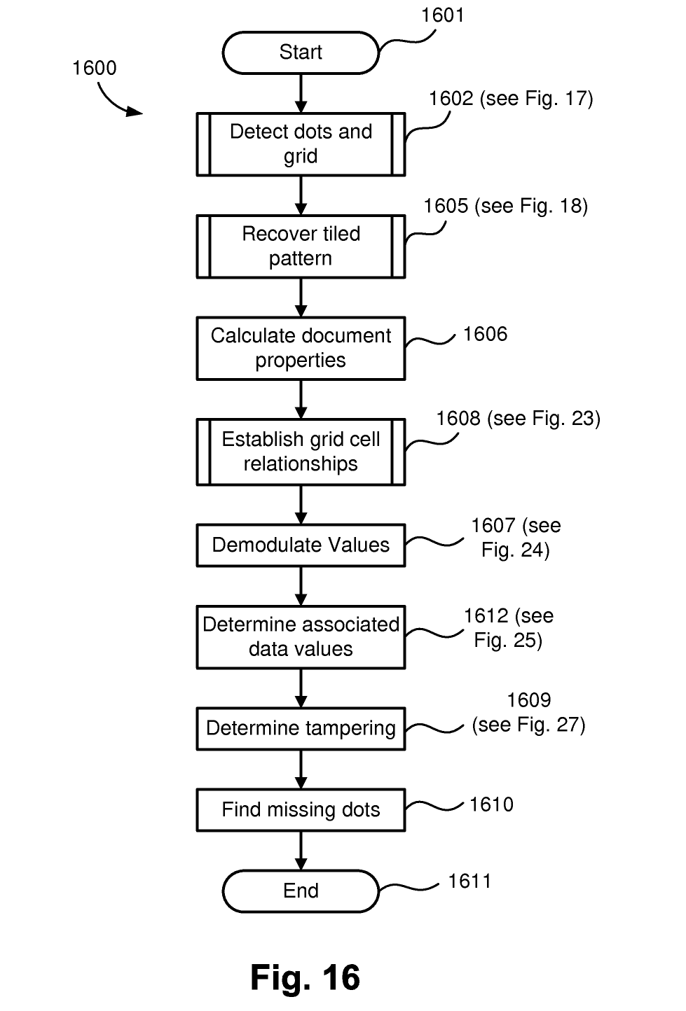

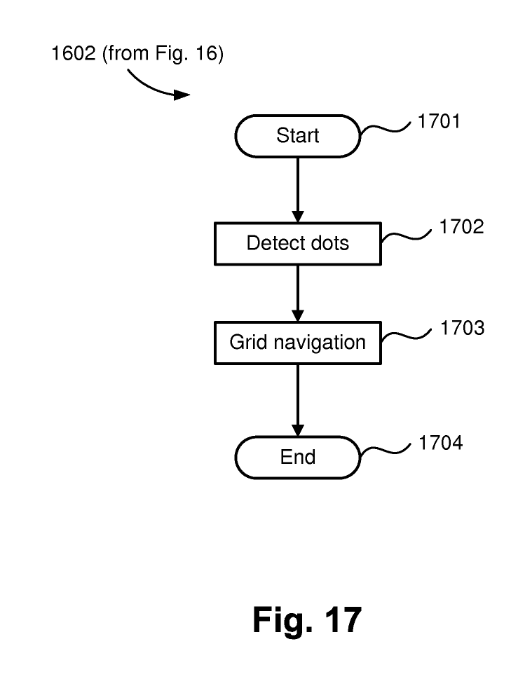

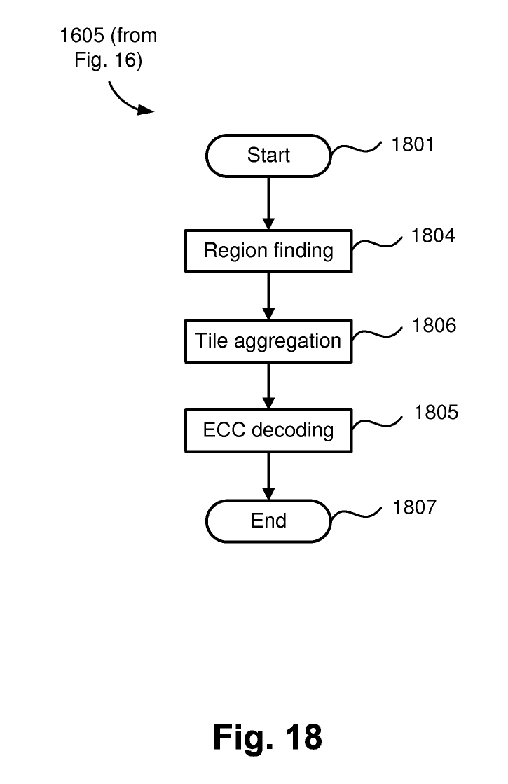

FIG. 16 is a flow diagram showing a method 1600 for verifying (ie decoding) a protected document (see 2910 in FIG. 29). The method 1600 is desirably performed as the software application 133 executable within the computer system 100 having input the protected document 2910 via the scanner 126.

The method 1600 commences with a start step 1601, which accepts as input a digital greyscale scan image 2907 of the protected document 2910. In one arrangement, the scan takes the form of an 8 bit greyscale JPEG image scanned at 600 dpi. The method then proceeds to a step 1602 where the digital greyscale scan of the protected document 2910 is processed by the processor 105 under the control of the SRDC application 133 to detect dots and recover the values encoded in them. This step is further detailed in FIG. 17.

FIG. 17 is a flow diagram illustrating a method 1602 of extracting intervals from protection dots on the protected document. The process 1700 begins at a step 1701 and proceeds to a step 1702. Heuristics are used by the processor 105 in the step 1702 to locate all protection marks in the digital grayscale scan of the protected document 2910. Due to the fact that dots are printed using normal colour printing processes, they may be easily detected using conventional image processing techniques. Dots printed using specialised printing processes may be detected by using appropriate methods that are known in the art. The output of the step 1702 is a list of (x, y) pixel coordinates of the centre of mass of each located protection mark.

During a following step 1703, a priority-based flood-fill algorithm is used to fit suitable grids over the locations of the dots that were located in the step 1702. In one case, the output of the step 1703, ie fitting a grid over the locations of the dots that were located in the step 1702, is a single grid that covers the entire digital grayscale scan of the protected document 2910. In other cases, multiple grids of different spacing and orientation cover the digital grayscale scan. For example, if the digital grayscale scan contains two or more barcodes (ie two or more sets of protection marks) that are disjoint, have different spacing or different orientations, a separate grid is output for each barcode detected. The process 1700 then terminates at a step 1704.

Returning to FIG. 16, the method 1600 proceeds to a following step 1605 where the grid extracted in the previous step 1605 is separated into regions, encoded values are extracted from dots and the tiled first channel described in the encoding section is detected. It is noted that in general the first channel, being essentially a pattern of dots which can be detected on decoding, may or may not contain data. However, the first channel does contain data in the first SRDC arrangement. This process is further detailed in FIG. 18.

FIG. 18 is a flow diagram illustrating a method 1605 of identifying the first channel structure and extracting the security feature from the first channel. The process 1800 begins at a step 1801 and proceeds to a following step 1804. In this step 1804, the values encoded in each dot in each grid identified in the step 1602 are decoded and each grid is divided into separate regions based on data similarity, using a segmentation algorithm.

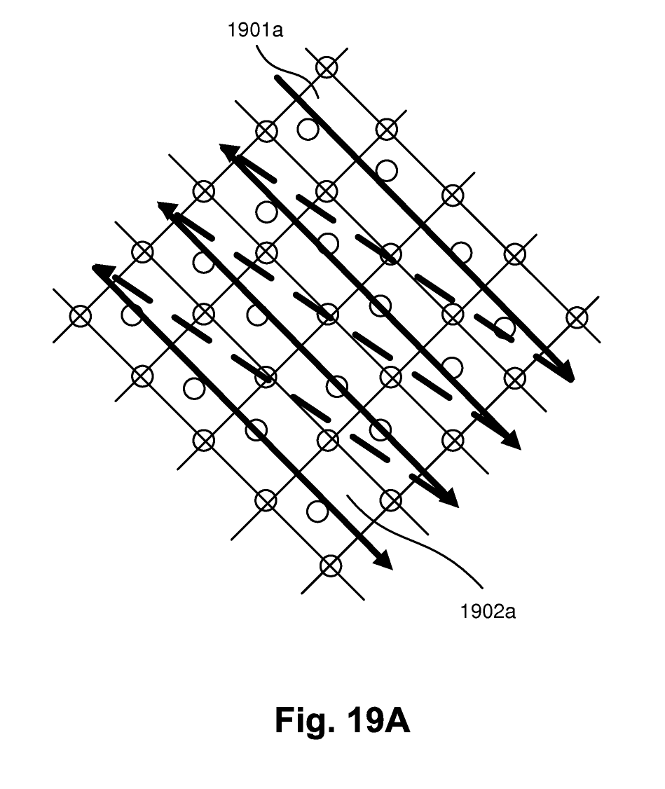

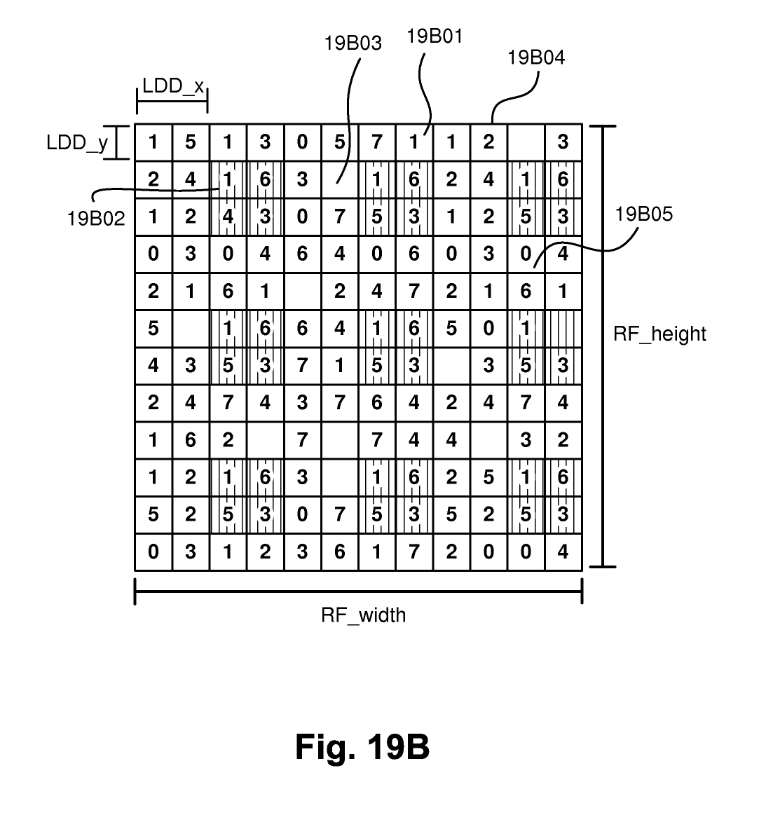

Generally, the output of the step 1804 is a single region defining a basis structural cell covering the grid. A 2D array of 3-bit numbers ‘intervals’ 19B01 (see FIG. 19B) is also part of the output of the step 1804. Every grid cell from the step 1703 is mapped to an interval in the array via its logical coordinate. The value of the interval is calculated as follows. Firstly, the location of the data dot in the grid cell is found. Then the vector from the centre coordinate to the data dot, called the ‘offset’, is calculated. Lastly, the offset is converted to an interval according to the modulation scheme shown in FIG. 5. Since protection dots can be missing or incorrectly detected from grid cells, blank or incorrect intervals 19B03 may exist in the array.

In special cases, multiple regions can be found. For example, if the grid contains two barcodes (ie sets of protection marks) that were not successfully separated during the step 1703, at this step 1806 they are correctly separated into two regions. Accordingly, the output from the step 1806 is two identified regions.

During a next step 1805, the data of the repeated pattern in each region is processed to define a single tile. The data of sections 705-708, illustrated in FIG. 7, is found by way of autocorrelation of the data of a number of tiles. Thus, the tiles in the identified region are summed into a single tile.

In FIG. 19B the LDD tiles 19B02 are shown as shaded. In the example portrayed in the figure, LDD tile size is 2 and LDD tile step size is 4, however these are not the values used in the first SRDC arrangement, and are simply chosen for ease of displaying the tiling scheme in the figure. (LDD_x, LDD_y), hereafter referred to as the ‘LDD offset’, is the displacement of the upper-left most LDD tile from the top left corner. The LDD offset is important for decoding, since it identifies the location of all the LDD tiles (LDD tiles repeat in fixed intervals). This aggregated tile is the output of the step 1805.

During a next step 1806, the aggregated tile is serialised into the LDD channel, any errors are corrected using the error correcting code, and the LDD Channel is decoded. The output of the step 1806 is the LDD message. The process 1605 finishes at a step 1807.

In another arrangement, a further output step may involve interpreting the binary sequence as a security message which contains information about the time, place and by whom the document was printed, or possibly some description of the security status of the document, which may ultimately dictate whether the document is able to be reproduced or not. The message to be stored in this channel should generally be of considerable importance, so as to take advantage of the high redundancy of the LDD channel.

A next step 1606 determines the average pixel intensity in an area (eg 1002 in FIG. 10) surrounding each grid intersection point of the protected document. Before determining the average pixel intensity, the digital greyscale scan 2907 of the received protected document 2910 is binarised to form a black and white image. In order to do this, firstly a filter function, such as a Gaussian blur, is applied to the digital greyscale scan. Next the digital greyscale scan is binarised, by applying a threshold function, to form a black and white image. This is the same process that is applied during the encoding process and is used to increase the similarity between the encoded image and the decoded image. The image binarisation process also removes the protection dots that were added during the encoding process.

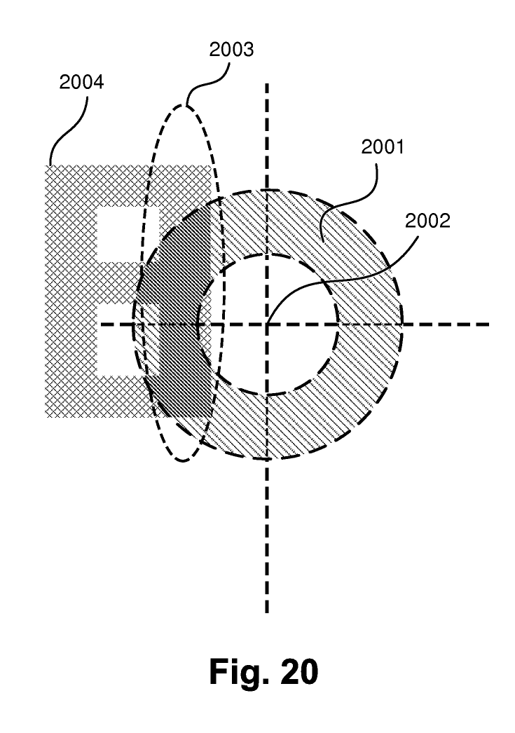

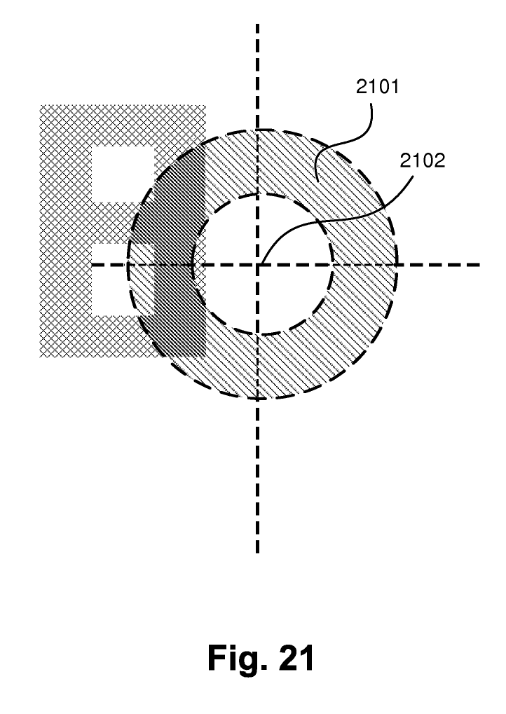

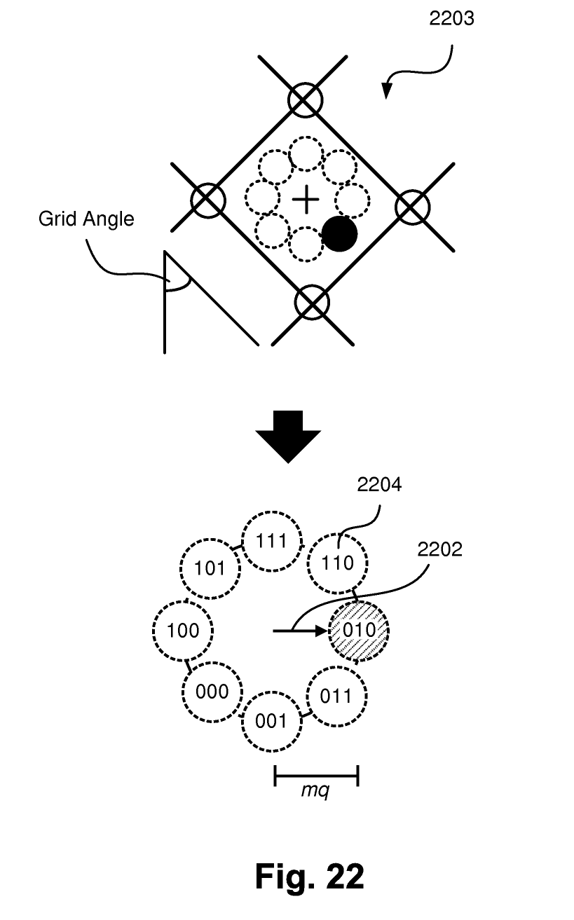

FIG. 20 illustrates a portion of a protected document that has been tampered with where an “E” has been changed to an “8”. In FIG. 20 the character ‘E’ 1003 From FIG. 10 has been tampered with to form an ‘8’ 2104. The tampered region is highlighted as depicted by 2003. In FIG. 21 the average pixel intensity of the area 2101 around the grid intersection point 2102 is measured.

With LDD step size and LDD offset extracted, the relationship between grid cells of the second channel and the areas they encode can be established. As described in step 905 grid cells 1208 are, on encoding, assigned a sample of the average pixel intensity 1206 from an area around the grid intersection point 1205, a pseudo-random data value and a possible a data value of a second pseudo-randomly selected grid cell 1212. Hence, each of the second channel protection dots output by step 1605 have been modulated by an image data value, a pseudo-random data value, and possibly the data value originally associated with some other grid cell within the same tile.

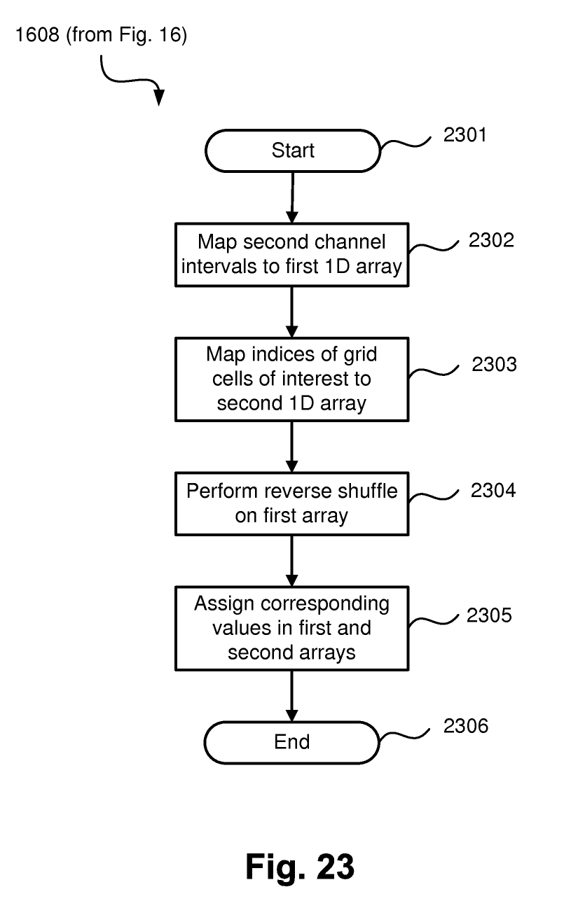

Returning to FIG. 16, in the step 1608, the shuffling performed in the step 906 is reversed. Firstly, using LDD tile step, and LDD offset, the second channel protection dots are identified. Each tile is then processed in turn using the process 1608 as depicted in more detail in FIG. 23.

FIG. 23 is a flow chart illustrating a method for determining which area on the document a second channel encodes. The process 2300 commences at a step 2301, and then proceeds to a following step 2302, where each interval extracted from second channel protection dots 1905a of the tile is mapped into the interval array in a predetermined manner, identical to that performed in the step 1304 in FIG. 13. The indices of grid cells of interest in the tile, namely the locations of which were established in the step 1303 in FIG. 13, and a possible arrangement of which are shown in FIG. 14, are then mapped to the indices array in a following step 2303. The interval array is then unshuffled in a following step 2304 using the inverse of the operation performed in the step 1307 in FIG. 13. The interval array and index array entries sharing common array indices now correspond in the respect that each interval array entry is the aggregate associated value for the grid cell with the index contained in the corresponding index array cell. The interval or aggregate associated value may be mapped to their corresponding grid cells within the tile, as is done in a following step 2305. The process then terminates at a step 2306.

In another SRDC arrangement, a shuffling scheme (906 and FIG. 13) similar to that in the first SRDC arrangement may be used. In this arrangement though, the seed for the shuffle (1307) described in the first SRDC arrangement is varied for each tile (701, 702, 703 and 704) in the tiled grid structure (717). There are a number of ways to achieve this.

In one arrangement, an error corrected message containing a seed may be encoded using dots from the second channel in each tile. On the encode step a seed may be chosen and used to perform the shuffle. The seed with its corresponding error correcting code may then be encoded as part of the second channel (709, 710 etc.). On the decode step, the seed is error corrected and recovered from the second channel. The seed is then used to generate the inverse shuffle operation that may then be performed to un-shuffle the interval array (2304).

In another arrangement, a seed may be generated for each tile from the values encoded in the second channel contained in adjacent tiles (i.e. the seed for the shuffle of the second channel in 701 may be generated from the values encoded in the dots of 702, 703, 704 or a combination thereof). For a starting tile, a known key may be used to generate the shuffle operation. This key may be encoded in the second channel message as per the method used in the arrangement outlined in the previous paragraph. Following that, the key for the adjacent tile (where the definition of adjacent is arbitrary but may—for example—be the tile to the left of the current tile in raster order) is chosen to be a hash of the second channel message of the current tile. A soft-hash is ideal in the case that the channel is noisy. As an extension, a number of tiles within the tiled grid structure may be chosen to be shuffled using the known key, rather than a key generated by a hash of adjacent tiles. This allows the decoding step to recover from the loss of a number of tiles.

Both of the above approaches serve to obscure the encoded data from a malicious user.

In another SRDC arrangement, the shape of the sampling area (1002) used to sample the pixel intensity around each grid point (1001) may be varied based on its location within the tile. For example, the radius of the annular ring may be increased based on the proximity of the sampling point to the first channel region of the tile (e.g. 705) i.e. the closer the sampling point is to the first channel region, the larger the radius of the sampling area. The rules for deciding the size of the filter may be chosen to maximize the evenness of anti-tamper coverage across each tile.

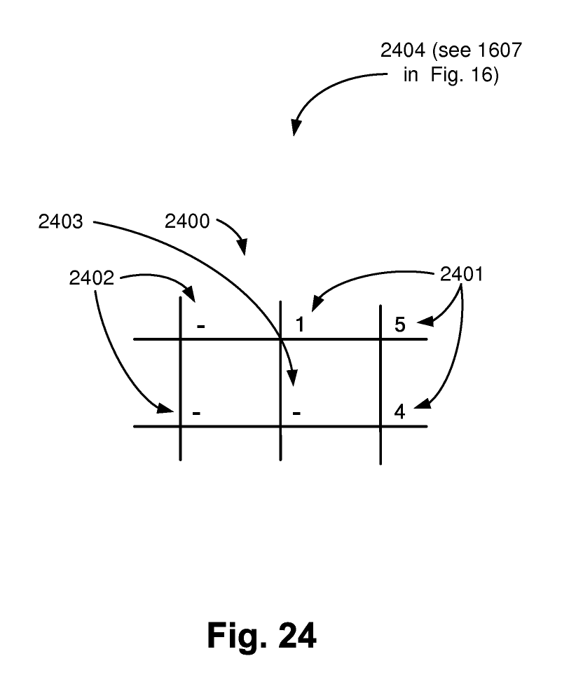

Returning to FIG. 16, a following step 1607 determines the pseudo-random data value 1101 associated with each grid cell 1102 and then demodulates the aggregate associated value by said pseudo-random number. In order to do this, all the grid cells that have an image intensity value less than a particular threshold sampled at their grid intersection points (examined in the step 1606) are considered. For example, suppose that in an arrangement 2404 depicted in FIG. 24, the grid intersection points at 2402, are found to have an average pixel intensity of 0. The aggregate associated values from their grid cells 2401 should match, or be close to, the pseudo-random data value 1103 used while encoding in FIG. 11. These values constitute the values of the extracted pseudo-random value grid. By knowing the pseudo-random data values 1103 used in the original pseudo-random value grid 1100 in FIG. 11, the extracted pseudo-random value grid 2400 (in FIG. 14) can be aligned with the original pseudo-random value grid 1100.

One technique for doing this alignment is by treating the pseudo-random numbers in the grids as intensities in images. Techniques for image alignment, such as phase correlation, can then be used to align the grids. Another technique for alignment is to take the pseudo-random numbers in all the rows of both grids, and append them together to create two strings of numbers. By searching for a fragment of one string in the other, the alignment can be found. There may be some small discrepancies between the encoded values and the pseudo-random grid if the previously described data-embedding scheme is used, meaning that a simple string comparison will not suffice.

Once the extracted pseudo-random value grid 2400, as illustrated in FIG. 24, has been aligned with the original pseudo-random value grid 1100, as illustrated in FIG. 11, the missing pseudo-random data values 2402 and 2403 can be determined as they correspond to the values 1101, 1104 and 1105.

The demodulated values of grid cell (ie the data values for data cells and the data carrying cells values for non-data carrying cells) are then determined by taking the grid cells aggregate associated value and then subtracting the grid cells associated pseudo-random data value, adding 8 if the result is less than 0 (or n in the case that some other modulation scheme is used, where the maximum encodable value is n−1).

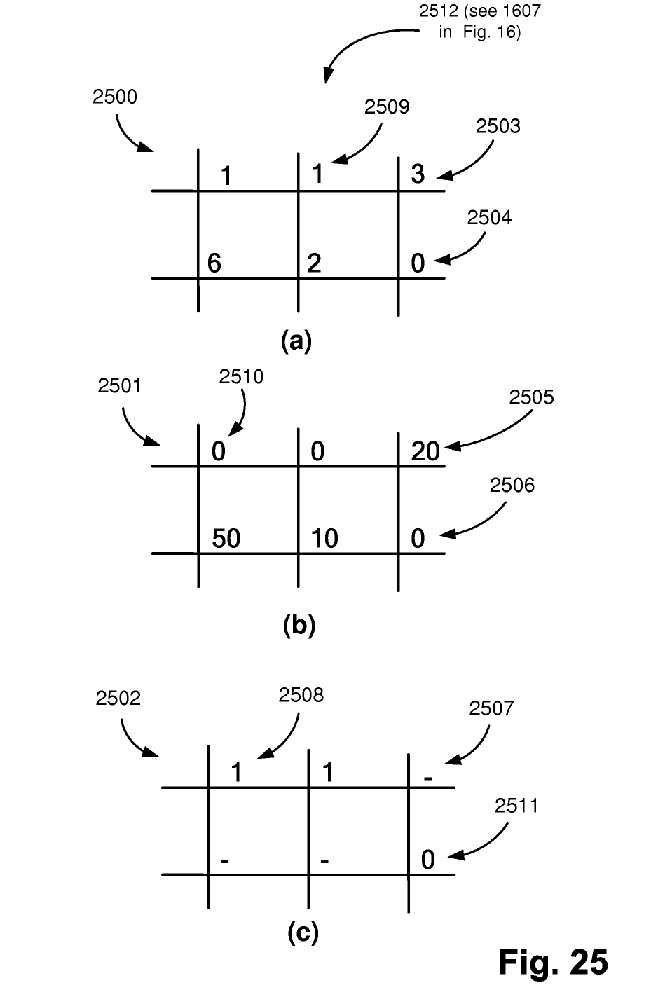

Returning to FIG. 16, a following step 1612 populates a data grid 2502 (see FIG. 25), similar to that in the encoding step 909, from the demodulated values extracted in step the 1607. For each grid cell, a corresponding image intensity value such as 2501 is observed. If it is less than some threshold, i.e. 2510, then the demodulated value is taken as the data value 2502 of the grid cell. A demodulated value of 0 (depicted by 2504) and an image intensity value of 0 (depicted by 2506) correspond to a binary 0 (depicted by 2511) in the data grid 2502, and a demodulated value of 1 (depicted by 2509) corresponds to a binary 1 (depicted by 2508). The co-ordinates that this value is to be assigned to in the data grid are inferred from the co-ordinates of the grid cell in the pseudo-random grid 2403 established in the previous step 1607. Demodulated values 2503 with corresponding image intensity values greater than some threshold 2505 are left as blank cells in the data grid 2507. When a data value is extracted from a demodulated value the demodulated value is changed to a 0. After all data values have been extracted from the demodulated value, the binary values in the data grid may be aggregated to reconstitute the original auxiliary message. At the end of this step, all demodulated values correspond to the originally encoded image data values.

Returning to FIG. 16, in a following step 1609 the image data value for each protection dot determined in the step 1612 is compared to the average pixel intensity measured in the step 1606. However, the protected document may have undergone some processing (such as printing and scanning) which may give a systematic error for all the grid cells. To overcome this, automatic calibration is conducted as a preliminary part of the step 1609. In particular, for each possible image data value (0-7 in the example described), every grid cell with that image data value is examined, and the mean of the image data values is calculated. A calibration map can be constructed from the image data values and the means calculated. The calibration map thus constructed provides a mapping from each image data values to a measured average pixel intensity. It is possible to use other statistical means to calculate the calibration map, for example by using the median values, or by plotting the values on a graph and using a line of best fit.

Document tampering is then detected. At each grid intersection point, the image data value of the grid cell is mapped to an expected value using the calibration map constructed in the step 1609. The difference is found between the expected value extracted from the dot and the image intensity value measured in the step 1606, giving an error at each grid intersection point. A greyscale bitmap image of the same size as the protected document is created to represent the tampering, with all pixels initialized to 0. Pixels in the aforementioned tamper image corresponding to each grid intersection point on the protected document are set to the error calculated for the grid cells to which those grid intersection points belong. A filter function (e.g. Gaussian blur) is applied to the tamper image so that the pixels containing errors are spread into their local areas. Preferably, this filter function is a similar shape and size to the area 1002 illustrated in FIG. 10, which was used while encoding the document.

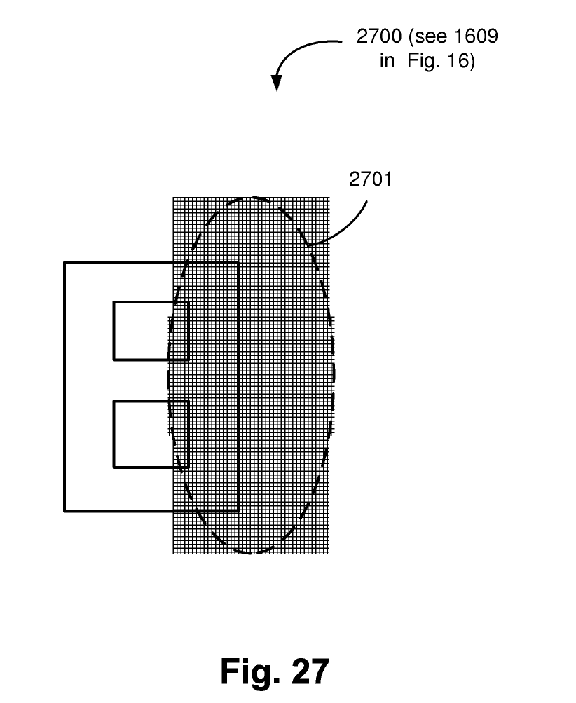

At this stage the tamper image has areas of 0 intensity representing untampered areas, areas which have negative values representing areas where content has been deleted, and areas with positive values representing areas where content has been added. By choosing a threshold value greater than 0, and setting all pixels below this to a threshold representing white, and all pixels above this threshold to a value representing black, the tamper image clearly displays areas where content has been added. It is possible to superimpose the tamper image onto the protected document, ideally converted to a conspicuous colour. An example result 2700 is shown in FIG. 27, with the tampered region 2701 highlighted.

In a similar way, a negative threshold can be chosen, and all pixels in the tamper image below this threshold set to a value representing black, and all pixels above this threshold set to a value representing white. The tamper image clearly displays areas where content has been deleted. This tamper image can also be superimposed onto the protected document, ideally converted to a conspicuous colour.

Returning to FIG. 16, in a following step 1610, a missing dots image representing tampering is created by finding all the grid cells where a dot could not be found or decoded. A greyscale bitmap image is created of the same size as the protected document where all the pixels are initialized to 0. Pixels corresponding to the grid intersections where dots are missing are set to a value higher than 0. Because it is expected that more dots will be missing in areas of high average pixel intensity (e.g. around text), the aforementioned value should be inversely proportional to the average pixel intensity. Next, a filter function (e.g. Gaussian blur) is applied to the missing dots image. A threshold is chosen, and all pixels above this threshold are set to a value representing black, and all pixels below this threshold are set to a value representing white. The missing dots image can also be superimposed onto the protected document, ideally converted to a conspicuous colour.

In one form, the aforementioned positive, negative & missing dots thresholds can be chosen interactively, e.g. by movable sliders on a graphical user interface. In this way, modifying the values of the thresholds changes the sensitivity of the detection process.

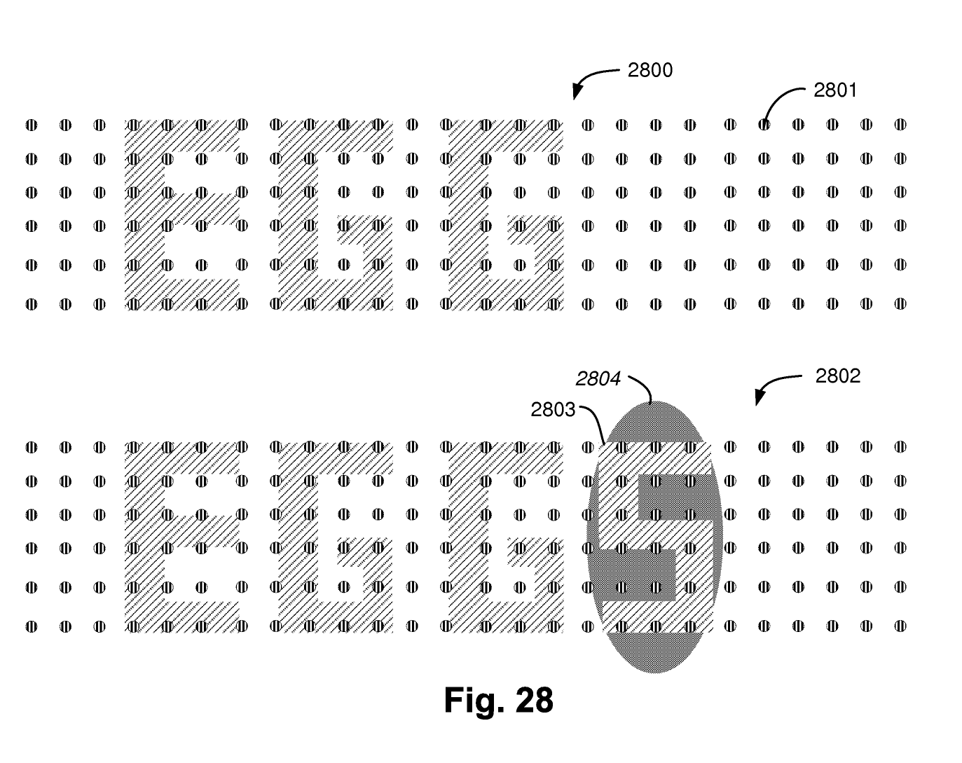

FIG. 28 depicts a protected document (see 2910 in FIG. 29) that has been altered in an unauthorised manner. After processing using the disclosed SRDC arrangements, considering FIG. 29, a processed received protected document 2912 is output, as depicted by an arrow 2913. The processed received protected document can be printed by the printer 115, or shown on the display 114. Returning to FIG. 28, a first view 2800 shows a fragment of a protected document upon which the word “EGG” and an associated array 2801 of protection dots has been printed. A second view 2802 shows the same document fragment after processing using the disclosed SRDC arrangements. In the second view, the word “EGG” has been amended, in an unauthorised manner, to read “EGGS”. The unauthorised amendment (ie tampering) comprising the added letter “S” (ie 2803) is clearly indicated by the highlighted area 2804 produced by the disclosed arrangements.

It is worth noting here that a number of the preceding steps can be performed together to avoid multiple iterations over the grid, but are explained in a stepwise fashion here for ease of understanding.

### INDUSTRIAL APPLICABILITY

The arrangements described are applicable to the computer and data processing industries and particularly for secure document processing.

The foregoing describes only some embodiments of the present invention, and modifications and/or changes can be made thereto without departing from the scope and spirit of the invention, the embodiments being illustrative and not restrictive.

1. A method of creating a protected document, the method comprising the steps of:
(a) providing a document having a plurality of marks encoding a security feature of the document, the plurality of marks having a structured arrangement corresponding to a plurality of areas, each area comprising a first region for storing security data and a second region for storing information related to an anti-tamper attribute of the first region;
(b) determining, based on the structured arrangement and a predetermined mapping for each said area, a correspondence between the first and second regions; and
(c) modulating the marks in the second regions to at least encode a characteristic of the first regions, wherein the modulated marks provide anti-tamper protection for the first region to create the protected document.

2. A method of protecting a document containing document information content, the method comprising the steps of:
defining a grid over the document the grid having grid intersection points whose locations relative to each other are predefined;
separating the grid intersection points into a repeating pattern of points, wherein each member of the repeating pattern comprises at least two subsets of points having a predefined spatial relationship, said subsets of points being associated with corresponding regions of the document; and
modulating, with respect to each member of the repeating pattern, protection mark attributes of protection marks associated with one of said subsets of points, to thereby encode information about the document information content of the regions of the document associated with all said subsets of points.

3. A method according to claim 2, wherein the modulating step modulates some of the protection marks associated with said one of said subsets of points to thereby encode ancillary information not associated with the document information content.

4. A method of creating a security document, according to claim 1, comprising the additional steps of:
(d) determining, based on the structured arrangement and a predetermined mapping for each said area, a correspondence between the second region and other parts of the second region; and
(e) modulating marks in the second regions to encode a characteristic of the second regions wherein the modulated marks provide anti-tamper protection for the second region to create the security document.

5. A method of creating a security document, the method comprising the steps of:
(a) providing a document having a plurality of marks encoding a security feature of the document, the plurality of marks having a structured arrangement corresponding to a plurality of areas, each area comprising a first region for storing security data comprising a repeating pattern of dots, and a second region for storing information related to an anti-tamper attribute of the area;
(b) determining, based on the structured arrangement and a predetermined mapping for each said area, a correspondence between the second regions and the entire area; and
(c) modulating some marks in the second region to encode a characteristic of the area, wherein the modulated marks provide an anti-tamper protection for the area to create the security document.

6. A method according to claim 1, wherein at least some marks in the second region are modulated to encode an auxiliary data channel.

7. A method according to claim 1, wherein said anti-tamper protection encodes information about the text of the document.

8. A method according to claim 1, where said anti-tamper protection encodes information about the document substrate in the marks.

9. An apparatus for creating a protected document, said apparatus comprising:
a memory for storing a program; and
processor for executing the program, said program comprising:
(a) code for providing a document having a plurality of marks encoding a security feature of the document, the plurality of marks having a structured arrangement corresponding to a plurality of areas, each area comprising a first region for storing security data and a second region for storing information related to an anti-tamper attribute of the first region;
(b) code for determining, based on the structured arrangement and a predetermined mapping for each said area, a correspondence between the first and second regions; and
(c) code for modulating the marks in the second regions to at least encode a characteristic of the first regions, wherein the modulated marks provide anti-tamper protection for the first region to create the protected document.

10. An apparatus for protecting a document containing document information content, said apparatus comprising:
a memory for storing a program; and
a processor for executing the program, said program comprising:
code for defining a grid over the document the grid having grid intersection points whose locations relative to each other are predefined;
code for separating the grid intersection points into a repeating pattern of points, wherein each member of the repeating pattern comprises two subsets of points having a predefined spatial relationship, said subsets of points being associated with corresponding regions of the document; and
code for modulating, with respect to each member of the repeating pattern, protection mark attributes of protection marks associated with one of said subsets of points, to thereby encode information about the document information content of the regions of the document associated with both said subsets of points.

11. An apparatus for creating a security document, said apparatus comprising:
a memory for storing a program; and
a processor for executing the program, said program comprising
(a) code for providing a document having a plurality of marks encoding a security feature of the document, the plurality of marks having a structured arrangement corresponding to a plurality of areas, each area comprising a first region for storing security data comprising a repeating pattern of dots, and a second region for storing information related to an anti-tamper attribute of the area;
(b) code for determining, based on the structured arrangement and a predetermined mapping for each said area, a correspondence between the second regions and the entire area; and
(c) code for modulating some marks in the second region to encode a characteristic of the area, wherein the modulated marks provide an anti-tamper protection for the area to create the security document.

12. A computer program product including a computer readable medium having recorded thereon a computer program for directing a processor to execute a method for creating a protected document, said program comprising:
(a) code for providing a document having a plurality of marks encoding a security feature of the document, the plurality of marks having a structured arrangement corresponding to a plurality of areas, each area comprising a first region for storing security data and a second region for storing information related to an anti-tamper attribute of the first region;
(b) code for determining, based on the structured arrangement and a predetermined mapping for each said area, a correspondence between the first and second regions; and
(c) code for modulating the marks in the second regions to at least encode a characteristic of the first regions, wherein the modulated marks provide anti-tamper protection for the first region to create the protected document.

13. A computer program product including a computer readable medium having recorded thereon a computer program for directing a processor to execute a method for protecting a document containing document information content, said program comprising:
code for defining a grid over the document the grid having grid intersection points whose locations relative to each other are predefined;
code for separating the grid intersection points into a repeating pattern of points, wherein each member of the repeating pattern comprises two subsets of points having a predefined spatial relationship, said subsets of points being associated with corresponding regions of the document; and
code for modulating, with respect to each member of the repeating pattern, protection mark attributes of protection marks associated with one of said subsets of points, to thereby encode information about the document information content of the regions of the document associated with both said subsets of points.

14. A computer program product including a computer readable medium having recorded thereon a computer program for directing a processor to execute a method for creating a security document, said program comprising
(a) code for providing a document having a plurality of marks encoding a security feature of the document, the plurality of marks having a structured arrangement corresponding to a plurality of areas, each area comprising a first region for storing security data comprising a repeating pattern of dots, and a second region for storing information related to an anti-tamper attribute of the area;
(b) code for determining, based on the structured arrangement and a predetermined mapping for each said area, a correspondence between the second regions and the entire area; and
(c) code for modulating some marks in the second region to encode a characteristic of the area, wherein the modulated marks provide an anti-tamper protection for the area to create the security document.

15. A method of decoding a protected document, the method comprising the steps of:
(a) providing a document having a plurality of modulated marks encoding a security feature of the document, the plurality of marks having a structured arrangement corresponding to a plurality of areas, each area comprising a first region for storing security data and a second region for storing information related to an anti-tamper attribute of the first region;
(b) determining, based on the structured arrangement and a predetermined mapping for each said area, a correspondence between the first and second regions; and
(c) demodulating the marks in the second regions to recover an anti-tamper protection characteristic of the first regions.

16. A method of decoding a protected document containing document information content, the method comprising the steps of:
fitting a grid over the document, said grid having grid intersection points whose locations relative to each other are predefined;
separating the grid intersection points into a repeating pattern of points, wherein each member of the repeating pattern comprises two subsets of points having a predefined spatial relationship, said subsets of points being associated with corresponding regions of the document; and
demodulating, with respect to each member of the repeating pattern, protection mark attributes of protection marks associated with one of said subsets of points, to thereby recover information about the document information content of the regions of the document associated with both said subsets of points.

17. A method of decoding a protected document containing document information content, said method comprising the steps of:
determining locations of modulated protection marks in the protected document, said marks being associated with protection content relating to said document information content;
fitting grid intersection points of at least one grid to said locations;
demodulating the protection marks;
identifying, based upon said demodulated marks, a set of said points which repeats across the protected document;
identifying, based upon demodulated marks associated with at least some of said repeating sets of points, at least two subsets of points in said repeating set of points, said at least two subsets of points having a predefined spatial relationship; and
determining information about the document information content dependent upon the protection content of the demodulated marks associated with said at least two subsets of points.

18. An apparatus for decoding a protected document, the apparatus comprising:
a memory for storing a program; and
a processor for executing the program, said program comprising
(a) code for providing a document having a plurality of modulated marks encoding a security feature of the document, the plurality of marks having a structured arrangement corresponding to a plurality of areas, each area comprising a first region for storing security data and a second region for storing information related to an anti-tamper attribute of the first region;
(b) code for determining, based on the structured arrangement and a predetermined mapping for each said area, a correspondence between the first and second regions; and
(c) code for demodulating the marks in the second regions to recover an anti-tamper protection characteristic of the first regions.

19. An apparatus for decoding a protected document containing document information content, the apparatus comprising:
a memory for storing a program; and
a processor for executing the program, said program comprising
code for fitting a grid over the document, said grid having grid intersection points whose locations relative to each other are predefined;
code for separating the grid intersection points into a repeating pattern of points, wherein each member of the repeating pattern comprises two subsets of points having a predefined spatial relationship, said subsets of points being associated with corresponding regions of the document; and
code for demodulating, with respect to each member of the repeating pattern, protection mark attributes of protection marks associated with one of said subsets of points, to thereby recover information about the document information content of the regions of the document associated with both said subsets of points.

20. An apparatus for decoding a protected document containing document information content, said apparatus comprising:
a memory for storing a program; and
a processor for executing the program, said program comprising
code for determining locations of modulated protection marks in the protected document, said marks being associated with protection content relating to said document information content;
code for fitting grid intersection points of at least one grid to said locations;
code for demodulating the protection marks;
code for identifying, based upon said demodulated marks, a set of said points which repeats across the protected document;
code for identifying, based upon demodulated marks associated with at least some of said repeating sets of points, at least two subsets of points in said repeating set of points, said at least two subsets of points having a predefined spatial relationship; and
code for determining information about the document information content dependent upon the protection content of the demodulated marks associated with said at least two subsets of points.
